(19) United States
(12) Patent Application Publication
(10) Pub. No.: US 2018/0247249 A1
(43) Pub. Date: Aug. 30, 2018

(54) CONTACT PLANNING SYSTEM

(71) Applicant: Prolifiq Software Inc., Portland, OR (US)

(72) Inventors: Anh Huynh, Tigard, OR (US); Hemingway Huynh, Salem, OR (US); Jeffrey Michael Farnsworth, Portland, OR (US); Isabella Wong, Bellevue, WA (US)

(21) Appl. No.: 15/755,054

(22) PCT Filed: Aug. 26, 2016
(86) PCT No.: PCT/US16/49138

§ 371 Date: Feb. 23, 2018

Related U.S. Application Data
(60) Provisional application No. 62/211,654, filed on Aug. 28, 2015.

(51) Int. Cl. G06Q 10/06; G06Q 10/10; G06F 3/0484

(52) U.S. Cl. CPC G06Q 10/06398; G06F 3/04847; G06Q 10/1097

(57) ABSTRACT

Systems, methods, computer-readable media, and apparatuses for contact planning is provided. A representative may provide a request a contact plan from a contact planning system. A contact planning system (CPS) may receive a request for a contact plan from a representative. The CPS may generate a contact plan for the representative based on setup information. The contact plan indicates individual providers for the representative to contact. The CPS may provide the contact plan to the representative, and may receive information regarding the contact plan from the representative. The CPS may update various metrics and may provide a modified contact plan to the representative based on the received information. Other embodiments may be claimed and/or described.

### RELATED APPLICATIONS

This application claims priority to U.S. Provisional Application No. 62/211,654, filed Aug. 28, 2015 entitled “CONTACT PLANNING,” which is hereby incorporated by reference in its entirety.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Representatives in certain industries (for example, pharmaceutical and medical device manufacturing), frequently contact providers of services (for example, health care providers) in order to educate and answer questions about the products or services they represent. These contacts may take many forms, including phone calls, video conferencing, and/or face-to-face communication. Oftentimes, representatives may set goals for making contact with providers and may review their progress toward these goals. For example, a representative may have a goal of a certain number of contacts with a particular provider, another goal of a certain number of contacts with a provider group, and another goal to discuss a particular drug or device with a particular number of providers. However, keeping track of these interactions can be difficult.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an arrangement for facilitating planning and measurement of contacts between representatives and providers, in accordance with various example embodiments;

FIG. 2 illustrates an example process for facilitating contact planning is illustrated in accordance with various embodiments;

FIG. 3 illustrates an example process for setting up information for contact planning is illustrated in accordance with various embodiments;

FIG. 4 illustrates an example process for generating a contact plan, in accordance with various example embodiments;

FIGS. 5-28 illustrate example user interfaces implemented according to the various example embodiments discussed herein, in particular:

FIGS. 5-11 illustrate example interfaces for target selection, in accordance with various example embodiments;

FIGS. 12-15 illustrate example interfaces to select providers to contact, in accordance with various embodiments;

FIGS. 16-20 illustrate example interfaces for tactic selection, in accordance with various example embodiments;

FIG. 21 illustrates an example interface showing a tactic conflict, in accordance with various example embodiments;

FIG. 22 illustrates another example interface showing a tactic conflict, in accordance with various example embodiments;

FIG. 23 illustrates an example interface showing a generated plan including tactic suggestions for listed providers;

FIG. 24 illustrates an example interface listing of provider preferences of a selected provider, in accordance with various example embodiments;

FIG. 25 illustrates an example calendar-based interface, in accordance with various example embodiments;

FIG. 26 illustrates another example calendar-based interface, in accordance with various example embodiments;

FIG. 27 illustrates a first view of an example progress indicator, in accordance with various example embodiments;

FIG. 28 illustrates a second view of the example progress indicator of FIG. 27, in accordance with various example embodiments;

FIG. 29 illustrates an example computer device in accordance with various example embodiments; and

FIG. 30 illustrates an example computer-readable media, in accordance with various example embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

Embodiments described herein are directed to, for example, methods, apparatuses, systems, and computer-readable media for facilitating planning and measurement of contacts between representatives and providers. In various embodiments, a contact planning system (“CPS”) may be configured to facilitate a user, such as a representative, in planning and measuring contacts with providers or other individuals. In various embodiments, the CPS may generate and provide a contact plan to a representative based on various criteria. In various embodiments, the CPS may be configured to provide various interfaces, including a calendar interface and input interfaces, which may allow a representative to provide the criteria for planning contacts with one or more providers. The various interfaces may be rendered in a web browser or in a container in a dedicated application implemented by a computer device. The various interfaces discussed herein allow for the distribution of contact plans to computer devices, such as mobile devices, that are not able to efficiently access a variety of data from various databases thereby improving the functionality of the computer device itself and a system include the computer device and the CPS. The various interfaces provided by the CPS may be configured to allow a representative to select one or more providers, such as by filtering one or more lists of providers according to various criteria, and to associate one or more providers with time periods. For example, a representative may drag and drop one or more providers onto a date on a calendar interface to indicate that those providers should be contacted on or around the selected date. In another example, a representative may move sliders along corresponding sliding scales to indicate criteria for contacting various providers.

In various embodiments, the CPS may facilitate the determination of one or more contact metrics for contacts made by one or more representatives to one or more providers. For example, the CPS may display a contact goal, such as a desired number of contacts for a particular provider and/or group of providers for a given time period. The CPS may also display information about how many contacts have been already made within that time period with the representative and/or with other representatives, the type of contacts made with a particular provider, and/or the topics discussed during those contacts. This information may then be used by the representative to determine how many additional contacts should be made with the provider and/or group of providers, the type of contact to be made, and/or the topics to be discussed during the contact. This determination may assist later planning, such as by dragging and dropping providers which have not been sufficiently contacted to the calendar interface. In various embodiments, the contact metrics may be updated to account for planned contacts. Later, when actual contacts are made, whether they are on the same dates or times as the planned contacts, the contact metrics may be updated.

In various embodiments, the CPS may also provide for modification and/or review of contact planning. Thus, in some embodiments, the CPS may optimize, or otherwise modify, a set of planned contacts to improve efficiency and/or progress toward goals. In various embodiments, the CPS may be configured to modify planned contacts to bring geographically-similar contacts closer in time together. In other embodiments, the CPS may be configured to modify planned contacts to prioritize providers based on tiers or other priority rankings for providers, groups, or drugs/devices being discussed. In various embodiments, the CPS may also be configured to provide for review of one or more planned contacts by one or more managers and to receive modifications and/or approval of a contact plan. These modified and/or approved planned contacts may be presented to a representative after modification and/or approval. Other embodiments may be described.

It may be noted that particular examples are provided, for the sake of example, with reference to particular roles or professions. For example, embodiments are described herein with reference to “providers”, “representatives”, “physicians”, etc. It may be noted, however, that various embodiments may be practiced to facilitate communication between various persons and/or roles, and that the embodiments and techniques described herein should not be read to be limited by any particular roles used for exemplary description. Additionally, while particular subject matter is offered as examples of types of information that may be discussed during a contact, such as, for example, “pharmaceuticals”, “drugs”, or “devices”, no particular limitation on the type of contacts should be implied. Further, “contacts” as used herein, may refer to various types of communication between different parties, including, but not limited to, audio, video, text, email, and in-person communications.

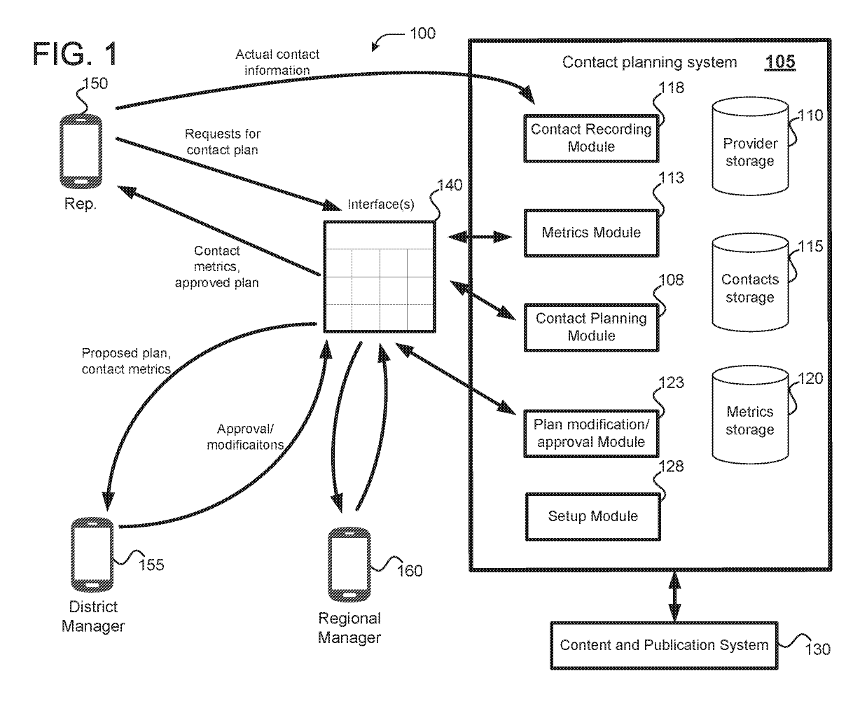

FIG. 1 illustrates an arrangement 100 for facilitating planning and measurement of contacts between representatives and providers is illustrated in accordance with various embodiments. In various embodiments, the CPS 105 may be configured to include one or more modules which may be utilized for facilitating contact planning. As discussed herein, the CPS 105 may be a computer device that comprises one or more processors, communications interfaces, and one or more memory devices. The one or more memory devices may include various software modules that may be implemented in various manners as may be understood, including program code firmware, middleware, microcode, hardware description languages, and/or any other like set of instructions and various combinations thereof. For example, the various modules may be configured to operate (through hardware and software) to perform the various procedures, processes, or operations as described herein. The various modules may be loaded into one or more memory devices and executed by one or more processors of a computer device. Execution of the various modules may cause the computer device to, among other things, generate, based on setup information, a contact plan for a representative that indicates individual providers of a plurality of providers for the representative to contact; provide the contact plan to a representative device 150 used by the representative; obtain indications of contacts between the representative and the individual providers indicated by the contact plan; and update metrics based on the indications of the contacts. While specific modules are described herein, it should be recognized that, in various embodiments, the one or more modules may be combined, separated into separate modules, and/or omitted altogether. Additionally, one or more modules may be implemented on separate devices, in separate locations, or distributed, individually or in sets, across multiple processors, devices, locations, and/or in cloud-computing implementations.

In some embodiments, the CPS 105 may include a contact planning module (“CP”) 108, which may be configured to provide one or more interfaces 140 for request of a contact plan by the representative. In embodiments, the interfaces 140 may include a plurality of graphical control elements that may allow the user of the representative device 150 to make a request for a contact plan based on a variety of criteria, such as filter criteria and targeting criteria. For example, the CP 108 may be configured to generate interfaces 140 for a representative device 150. That representative device 150 may utilize graphical control elements in the interfaces 140 to request a contact plan, such as by requesting a particular set of planned contacts with one or more providers according to desired targeting criteria. Targeting criteria may be any information that may be used to contact a provider. In embodiments, the desired targeting criteria may include a desired periodicity for contacting a provider (for example, once a week, once a month for three months, and the like), one or more desired topics (for example, to discuss a particular drug or class of drugs, to discuss improper dosing issues, and the like), and/or one or more desired tactics for contacting a provider (for example, lunch or dinner discussions, phone calls, emails, drug or device presentations, and the like).

As discussed herein, in various embodiments, the interfaces 140 may include a calendar interface provided by the CP 108, which may be configured to allow a user of the representative device 150 to drag and drop one or more listed providers onto particular time periods, such as individual days, weeks, and/or months. In various embodiments, the CP 108 may generate a contact plan for the representative based on the interactions with the interfaces 140. In various embodiments, the CP 108 may be configured to filter one or more lists of providers, such as based on provider information, representative information, past contacts with the providers, provider preferences, scheduling conflicts or issues with planned contacts or tactics, goal completion, etc. These filtered providers may then be used as input to request a contact plan. Through the use of filters, the representative may be better able to create contact plans for providers for which contact is most desired.

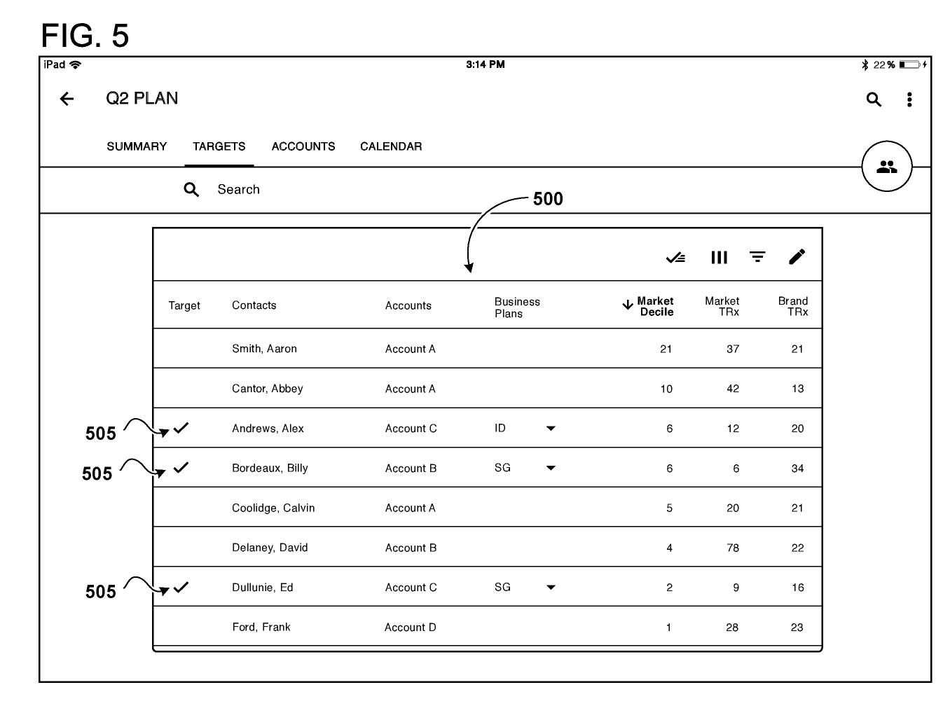

It may be noted that, in various embodiments, the CP 108 (as well as other modules a services discussed herein) may interact with a representative device 150 in various manners. For example, the representative device 150 may be a computing device, such a tablet, smartphone, laptop, or desktop computer, which may implement a CPS dedicated application to communicate with the various modules of the CPS 105 and display information to and receive responses from a user of the representative device 150. For example, the CPS dedicated application may be a native or hybrid mobile application that includes a container or skeleton configured to execute CPS dedicated programs/tasks and render CPS dedicated interfaces (e.g., webpages, interfaces for web applications, and the like). Such interfaces may be the same or similar to those shown and described with regard to FIGS. 5-28. In some embodiments, the CPS dedicated application may be a native application developed using platform-specific or operating system (OS)-specific development tools and/or programming languages. In some embodiments, the CPS dedicated application may be a hybrid application that uses a browser or rendering engine of the representative device 150 to render the various interfaces. The hybrid application may be developed using website development tools and/or programming languages, such as Hypertext Markup Language (HTML), Cascading Style Sheets (CSS), JavaScript, Node.js, PHP, ASP.NET, and/or any other like website development tools. In other embodiments, the CPS dedicated application may be a web application, wherein the representative device 150 may utilize a browser, such as a web browser, which may be served interfaces (e.g., webpages and/or interfaces for web applications) from the CPS 105 (e.g., from the CP 108). The aforementioned interfaces may be any server-side application that is developed with any server-side development tools and/or programming languages, such as PHP, Node.js, ASP.NET, and/or any other like technology that renders HTML. Other methods of interacting with the calendar-based interface and other interfaces described herein may be used.

In various embodiments, CPS 105 may also include a metrics module (“MD”) 113 (also referred to as a “metrics presentation module,” a “metrics determination module,” and the like), which may be configured to provide information regarding contact metrics associated with the representative and/or with one or more providers. For example, the MD 113 may be configured to provide metrics through the calendar-based interface of interfaces 140 provided by the CP 108. In other embodiments, the MD 113 may be configured to provide a separate contact metrics interface, which may be one of the interfaces 140. In various embodiments, the contact metrics provide by the MD 113 may be based on one or more goals to be met by a representative for contact with one or more providers. For example, the representative 150 may have a goal to meet with a provider a pre-set number of times during a time period. In another example, the representative may have a goal to meet with providers of a group (for example a hospital or a practice) a pre-set number of times in a time period. In another example, the representative may have a goal to discuss a pharmaceutical or device (or a group or class of pharmaceuticals or devices) a pre-set number of times in a period of time. In yet other embodiments, the representative 150 may have a goal to perform particular types of contacts, such as one face-to-face contact, two phone calls, and five emails, in a particular time frame. Other types of goals and contact metrics may be utilized and contemplated.

In various embodiments, the CPS 105 may also include a plan modification/approval module (“PM”) 123, which may be configured to facilitate modification of a contact plan and/or approval of the contact plan by one or more managers. In various embodiments, the PM 123 may be configured to modify planned contacts in a contact plan to optimize those planned contacts. For example, the PM 123 may be configured to change planned dates for one or more contacts to allow contacts for providers which are physically proximate to each other and/or which are in the same group to be reorganized so that the contacts are closer together in time. In another example, the PM 123 may be configured to change planned dates for one or more contacts to allow contacts based on higher-tier providers or for higher-tier drugs or devices to be prioritized in time over those for lower-tier providers, drugs, or devices. In another example, the PM 123 may be configured to change planned tactics for contacting a provider based on the desired targeting criteria (for example, a desired tactic of a lunch discussion) provided by the representative device 150 to the CPS 105 and/or based on provider preferences (for example, the provider prefers phone or email contact rather than lunch discussions), which may be obtained from the provider storage 110 and/or contacts storage 115. In another example, the PM 123 may be configured to change planned tactics for contacting a provider based on the desired targeting criteria (for example, a desired tactic of a lunch discussion on a particular date for a particular provider) provided by the representative device 150 to the CPS 105 and/or based planned contacts of another representative (for example, another representative has a lunch with the provider planned for a date/time similar to the date/time indicated by the desired tactic), which may be obtained from the provider storage 110 and/or contacts storage 115. In various embodiments, the PM 123 may be configured to perform such optimization through the application of one or more business rules to information relating to the contacts, including, but not limited to, contact type, dates, providers, representatives, etc.

In various embodiments, the PM 123 may also be configured to send one or more contact plans to one or more managers for modifications and/or approval. In various embodiments, the contact plans may be presented using the same (or similar) calendar-based interface discussed above. In various embodiments, one or more managers may be facilitated by the PM 123 in reviewing a contact plan, making modifications to the contact plan, and in approving or rejecting the contact plan (either in original or modified form). An approved or rejected contact plan may then be sent back to the representative (again using the same or similar calendar-based interface) for review. As illustrated in FIG. 1, in various embodiments, more than one manager may review and modify/approve/reject a contact plan. For example, a District Manager device 155 may first receive a proposed plan and may approve the plan, followed by a Regional Manager device 160. In various embodiments, managers may review and approve/reject in a particular order (such as District Manager device 155, followed by Regional Manager device 160, and the like) or the managers may review in parallel. Other structures of managerial review may be utilized in various embodiments.

After receiving an approved (and possibly modified) contact plan, the representative may then perform the planned contacts in the contact plan. In various embodiments, planned contacts may be performed on the dates/times they are planned for; in others, the planned contacts may be performed on other dates/times. In various embodiments, the CPS 105 may include a contact recording module (“CR”) 118 which may be configured to receive and record one or more indications of completed contacts with providers. For example, the representative may indicate, through use of the calendar-based interface of the interfaces 140, that a planned phone call occurred with a provider, such as by checking a check box or other like graphical control element associated with the contact. The CR 118, in response, may record an indication that the contact occurred. This may cause the MD 113 to update its contact metrics for that representative and/or provider.

Also as illustrated in FIG. 1, the CPS 105 may include various databases stored in the one or more memory devices associated with the CPS 105. These databases may be configured to receive and maintain information received by the CP 108 or CR 118, and to provide information to the various modules of the CPS 105 to facilitate the activities performed thereby. These databases may include: provider storage 110 configured to store information about providers; contacts storage 115 configured to store contact information, information relating to contacts previously performed between providers and representatives (also referred to as “contact history”), availability information, etc.; and metrics storage 120 configured to store information relating to goals and contacts metrics, as well as tier information and provider interaction history. The various types of information stored by the databases is discussed in more detail infra.

The aforementioned databases may include a relational database management system (RDBMS), an object database management system (ODBMS), a column-oriented DBMS, a correlation database DBMS, and the like. These databases may also be associated with applications or application programming interfaces (APIs) that enable the various modules of CPS 105 to perform querying and/or storage of information in the databases. Any suitable query language may be used to query and store information in the databases, such as structured query language (SQL), object query language (OQL), and/or other like query languages.

Additionally, the CPS 105 may also include a setup module (“SM”) 128, which may be configured, in various embodiments, to receive and store setup information prior to communications described herein. The SM 128 may also be configured to add to the setup information outside of the context of particular communications on an ongoing basis. The setup information may include, for example, provider information, tier indicators, contact goals, contact history, availability information, provider interaction history, and/or other like information. The various types of setup information may be obtained from the provider storage 110, the contacts storage 115, and the metrics storage 120. In addition, to obtain at least some of the provider information, the SM 128 may interact with the content and publication system 130 and its associated databases (not shown). In this regard, the SM 128 (or some other module of the CPS 105) may obtain digital content objects distributed to or by various providers. The digital content objects may be any type of content that a provider has obtained, requested, downloaded, or forwarded to other providers, such as journal articles, publications, literature produced/published by pharmaceutical manufacturers and/or medical device manufacturers, video content, and/or other like media. In some embodiments, the content and publication system 130 may communicate with computer devices used by various providers to track and/or obtain content consumed using those computer devices. In addition, the content and publication system 130 may or communicate with content distribution systems to obtain digital content objects that were previously distributed to various providers by various representatives. Furthermore, the content and publication system 130 may obtain digital content objects from a variety of sources, such as websites associated with scientific, academic, and/or research institutions.

Although FIG. 1 shows the content and publication system 130 and the CPS 105 as separate entities, in some embodiments, the content and publication system 130 may be implemented in or by the CPS 105. Furthermore, the CPS 105 may, in various embodiments, include other modules and/or facilities not illustrated in FIG. 1, as may be described herein.

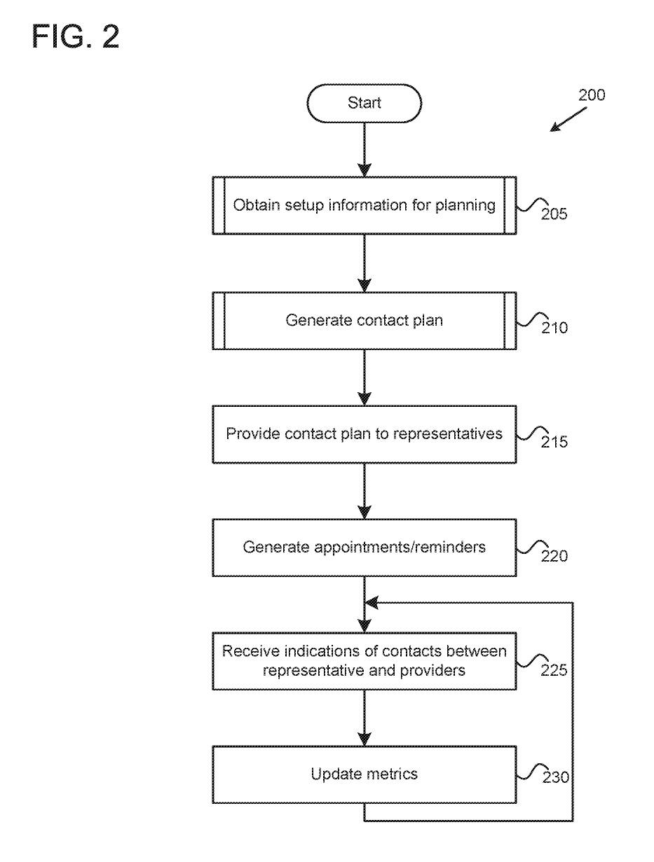

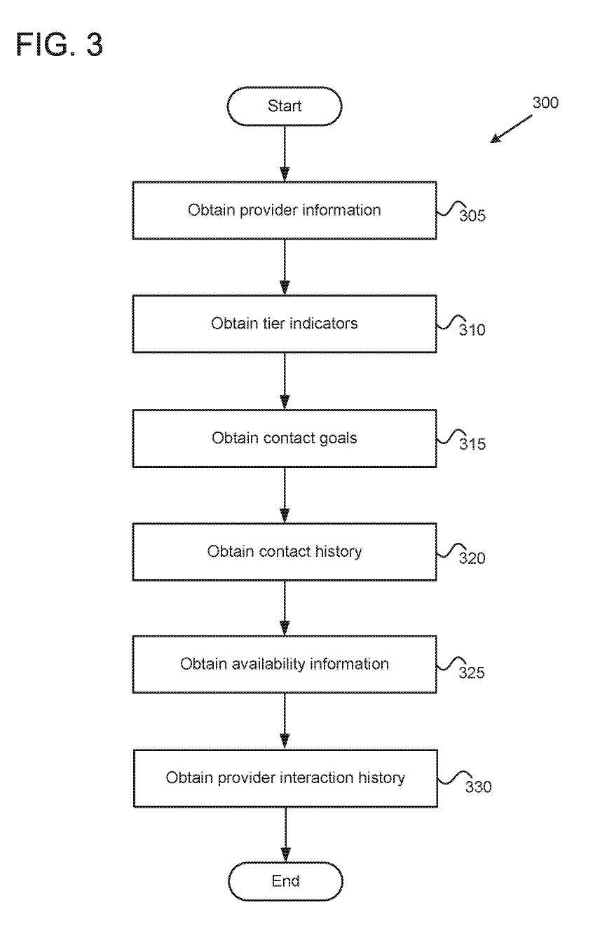

Referring now to FIG. 2, an example process 200 for facilitating contact planning is illustrated in accordance with various embodiments. For illustrative purposes, process 200 is described as being performed by the various modules of CPS 105 as shown and described with regard to FIG. 1. While FIG. 2 illustrates particular example operations, in various embodiments, the process 200 may include additional operations, omit illustrated operations, and/or combine illustrated operations. The process 200 may begin at operation 205 where the CPS 105 and in particular, the SM 128, may obtain setup information about providers, representatives 150 and/or drugs and devices in order to facilitate future contact planning. Particular implementations of this operation are described below with reference to FIG. 3. It may be noted as well that, while the process of FIG. 2 illustrates operation 205 as occurring in an initial point in time, in various embodiments operation 205 may be performed before, during, or after communications and/or may be repeated.

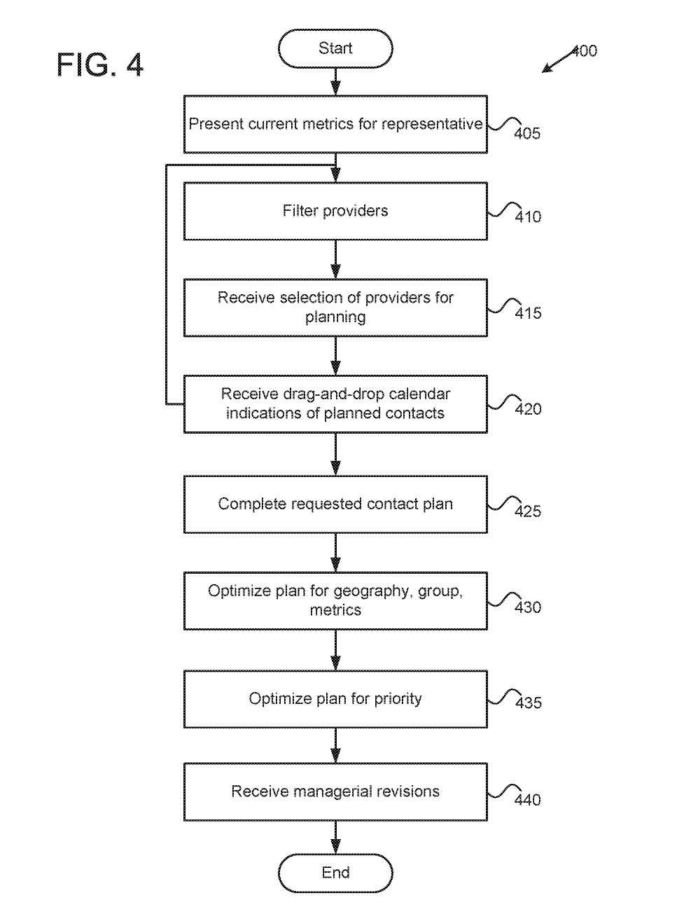

Next, at operation 210, the CPS 105, and in particular the CP 108, may generate a contact plan. In various embodiments, generation of a contact plan may include receiving a request for a contact plan, modifying the contact plan according to one or more optimizations, and/or obtaining approval for the contact plan. Particular implementations of this operation are described below with reference to FIG. 4. Next, at operation 215 the CPS 105 may provide the contact plan to one or more representatives 150. In various embodiments, the contact plan may be presented through the interfaces 140, such as a calendar-based interface and/or other interfaces discussed herein (and shown and described with regard to FIGS. 5-28). In other embodiments, other forms, such as textual plans, may be utilized. In various embodiments, the contact plan may be provided to multiple representatives. For example, a representative device 150 may be provided the ability to see other planned contacts for other people in that representative's team, or other contacts that are planned for a particular provider.

Next, at operation 220, the CPS 105 may generate appointments and/or reminders based on the provided contact plan. For example, the CP 108 may provide appointments and/or reminders to a separate calendaring program of one or more representative devices 150. Provision of appointments and/or reminders may better ensure follow-up by representatives. Next, at operation 225, the CPS 105, and in particular the CR 118, may receive indications of contacts that have been performed between the representative using representative device 150 and one or more providers. For example, the representative device 150 may, using the interfaces 140, indicate that a planned contact has occurred. In various embodiments, at this operation, the representative device 150 may also indicate additional information, such as the success of the contact, whether future contacts are warranted or should be encouraged, whether follow-up is desirable, etc. After receipt of contact indications by the CR 118, the indications may be stored in the metrics storage 120 and the metrics updated at operation 230. In various embodiments, the MD 113 may update the representative device 150's progress toward various goals at operation 230. In some embodiments, this updated information may be provided to the MD 113 and/or CP 108 for later contact planning. In some embodiments, the indications of the contacts may be stored in association with targeting criteria indicated by the generated contact plan. CPS 105 may then loop back to operation 225 for to receive additional indications of contacts and update the metrics accordingly. The process 200 may repeat as necessary or end.

Referring now to FIG. 3, illustrates an example process 300 for setting up information for contact planning, in accordance with various example embodiments. While FIG. 3 illustrates particular example operations, in various embodiments, the process 300 may include additional operations, omit illustrated operations, and/or combine illustrated operations. In various embodiments, the process of FIG. 3 may be performed by the SM 128, and may include operations by the provider storage 110, contact storage 115, and/or metric storage 120. The process 300 may begin at operation 305, where the SM 128 obtains provider information for one or more providers. The provider information may be obtained from the provider storage 110 and/or the content and publication system 130. In various embodiments, the provider information may include, but is not limited to: geographical location; association with particular provider facilities, hospitals, hospital networks, distributor networks, call centers, practices and/or clinics; association with particular professional groups; practice specialties; patient population information; preferred language; etc. In some embodiments, the provider information may include information regarding digital content objects that a provider has obtained, requested, downloaded, or forwarded to other providers, such as journal articles, publications, literature produced/published by pharmaceutical manufacturers and/or medical device manufacturers, video content, and/or other like media. Such information may be obtained using processes described by U.S. application Ser. No. 13/032,461 titled “Tracking Digital Content Objects,” U.S. application Ser. No. 13/841,982 titled “System for Multi-Point Publication Syndication,” U.S. application Ser. No. 14/511,140 titled “Selective Sharing of Electronic Information” and/or the like. The provider information thus obtained may be provided to and stored in the provider storage 110.

Next, at operation 310, the SM 128 may obtain tier information (also referred to as “tier indicators”) for one or more providers or products. For example, the SM 128 may obtain indications of different priority providers, such as those providers which are deemed likely to prescribe a particular drug or class of drugs (or utilize particular devices), or those who have not been contacted as much in a particular time period. In another example, the SM 128 may obtain information about providers with which the representative device 150 (and/or other representative devices 150) have had particular success, or lack thereof, thus indicating higher or lower tiers of priority. In another example, the SM 128 may obtain indications of pharmaceuticals or devices which are deemed to be of higher priority than other pharmaceuticals or devices. In embodiments, the tier indicators may be obtained from the metrics storage 120.

Next, at operation 315, the SM 128 may obtain goals for contact metrics for contact with particular providers. In various embodiments, goals may be obtained with particularity to particular providers, to particular groups, to particular geographical areas, etc.

Next, at operation 320, the SM 128 may obtain contact history indicating contact that has previously occurred with the providers. Such contact history may then be used to set up current metrics for the representative and/or providers.

Next, at operation 325, the SM 123 may obtain availability information for specialists/providers from the contacts storage 115. In various embodiments, the availability information may include, but is not limited to: time availability; date availability; connection bandwidth; etc. In various embodiments, the availability information may also include information about particular providers with which the specialist has been associated. For example, in some embodiments, one or more medical specialists may be associated ahead of time with a particular group of physicians in order to better ensure that specialists are available when needed for communications. Last illustrated, at operation 330, the SM 128 may then obtain specialist/provider interaction histories from the metrics storage 120. In various embodiments, such specialist/provider interaction history may include notes about particular interactions between the provider and the specialist, modes of communication (by phone, video conference, email, etc.) ratings or review of specialists by providers, etc. After completion of the various operations for obtaining information, the SM 128 may repeat the process as necessary, in whole or in part, at various times.

Referring now to FIG. 4, an example process 400 for generating a contact plan is illustrated. While FIG. 4 illustrates particular example operations, in various embodiments, the process 400 may include additional operations, omit illustrated operations, and/or combine illustrated operations. The process 400 may start at operation 405, where the MD 113 may present current metrics for a representative to the representative device 150. In various embodiments, these metrics may be presented with reference to one or more goals for the representative (or for multiple representatives 150, such as if the representative is part of a team).

Next, at operation 410, the CP 108 may filter one or more providers. In various embodiments, the CP 108 may receive one or more filter criteria from the representative device 150 through the interfaces 140, and may filter a listing of providers based on this criteria. In various embodiments, filter criteria may include, but is not limited to, provider identity, provider location, provider group or account, provider tier, level of goal completion with provider, recentness of contact with provider, provider preferences, desired tactics, etc. Next, at operation 415, the CP 108 may receive a selection of one or more providers from the representative device 150 through the interfaces 140. In various embodiments, the selected providers may include providers that were previously filtered. In some embodiments, one or more of the providers may be selected for the representative by one or more managers (for example, manager devices 155, 160 may provide selected providers to the CPS 105).

After receiving the selection of providers, at operation 420 the CP 108 may obtain targeting criteria. The user of representative device 150 may provide the targeting criteria to the CPS 105 using one or more interfaces 140. For example, the CPS 105 may receive an indication of a date and/or time when the representative wishes to contact the selected providers. This may be done, for example, by receiving an indication that the user of the representative device 150 has dragged the selected providers and dropped them into the calendar-based interface of the interfaces 140. In another example, the targeting criteria may include a desired periodicity or repetition for contacting the selected providers. In another example, the targeting criteria may include one or more desired topics to discuss, such as improper dosing issues, growth of epidemiology (EPI) markets, share growth, and the like. In another example, the targeting criteria may include one or more desired tactics (for example, a phone call, scheduled lunch meeting, presentation, drug or device samples, and the like). In various embodiments, the filter, select, and calendar indications may be repeated for additional providers.

In some embodiments, instead of, or in addition to receiving selected providers from the representative device 150, the providers may be selected by the CPS 105 based on the targeting criteria received at operation 420. For example, in some embodiments the CPS 105 may receive, from the representative device 150, an indication of desired topics to discuss with potential providers.

At the completion of this repeated process, at operation 425, a requested contact plan may be completed. After the contact plan is completed, at operation 430 the PM 123 may optimize the contact plan based on geography, provider and/or group information, and/or metrics. As mentioned above the PM 123 may organize providers that are proximate to each other to be near in the schedule of the contact plan. In another example, the PM 123 may organize providers that are part of the same group to be near each other in the schedule. In yet another example, the PM 123 may optimize the contact plan based on metrics for the representative using representative device 150, or for multiple representatives, such as to prioritize contacts with providers for whom metrics are furthest away from their associated goals. In yet another example, the PM 123 may optimize the contact plan based on provider information and other planned contacts, such as to avoid scheduling conflicts with other representatives and/or avoid planning contact tactics that conflict with a provider's preferences. In various embodiments, the PM 123 may also generate recommendations for planning contacts and tactics for the representative using the representative device 150. Next, at operation 435, the PM 123 may optimize the contact plan based on priority. In embodiments, the PM 123 may move higher-tier providers (or providers for whom higher-priority subjects are to be discussed) higher in the schedule so that they may be contacted earlier than lower tiered providers and/or in accordance with their preferences. At operation 440, after plan and priority optimization, the PM 123 may send the requested/modified contact plan to one or more manager devices 155, 160 to receive their approval. After approval is received, the process 400 may end and/or return to process 200 to provide the contact plan to the representatives (see operation 215 shown and described with regard to FIG. 2).

FIGS. 5-28 illustrate example interfaces facilitated by the CP 108, MD 113, and/or PM 123 according to various techniques described herein. In particular, each of FIGS. 5-28 illustrate example interfaces that may be displayed on a representative device 150 (such as interfaces 140 discussed previously). The example interfaces may be displayed or rendered by a CPS dedicated application implemented by the representative device 150. While particular example interfaces are illustrated, in various embodiments, other interfaces may be utilized. Additionally, while the examples of FIGS. 5-28 may be generated by modules of a device associated with the representative, in other embodiments, the interfaces may be generated, in whole or in part, by modules at the CPS 105 and presented by communication modules of the representative's device (e.g., the device communications modules may include a browser displaying one or more web pages provided by the CPS 105).

FIGS. 5-11 illustrate example interfaces for target selection, in accordance with various example embodiments. At FIG. 5, an interface 500 shows a listing of providers for contact in a given period (“Q2” or “second quarter”). The listing shown by FIG. 5 may occur as a result of requesting a filtered list of providers from the CPS 105. As illustrated, providers may be grouped by the CPS 105 grouped into or otherwise associated with an account. An account may be any type of provider grouping, such as by practice group, specialty, institution (for example, a hospital, medical school, etc.), and the like. The illustrated listing shows, for each provider, an account or group associated with the provider, as well as a business plan (also referred to as a “plan” or “targeting criteria”) and target metrics. The target metrics include market decile, market total prescriptions (TRx), and brand TRx. The plan may indicate a particular guide or strategy for contacting a particular provider. For example, FIG. 5 shows an improper dosing (ID) plan for provider Alex Andrews and a share growth (SG) plan for provider Bill Bordeaux. The market decile may be a performance ranking of a provider, which may indicate a provider's likelihood to prescribe a given drug (or use a particular device) based on, for example, a number of TRxs and new prescriptions (NRx) that each provider writes over a predetermined period of time. The providers may then be deciled into various groups based on their writing patterns. Other factors may be used to determine the market decile, such as drug or device pricing information, accessibility of the physician, adoption sequence, tendency of a provider to use a particular pharmaceutical company's drugs or medical device manufacturer's devices, influence the provider has on other providers, and/or other like factors. The market TRx may be a total amount that a given drug is dispensed and the brand TRx may be a total amount that a given brand-name drug is dispensed. The market TRx and the brand TRx may be used by representatives to gauge a drug's performance with a particular provider. In addition, interface 500 also shows targeted providers 505 for the user of the representative device 150 to contact. In embodiments, the targeted providers 505 may have been selected by the CPS 105, a manager device 155 or 160, or by the representative device 150 based on various selection criteria. As shown, the targeted providers 505 may be represented with check marks and bolded text.

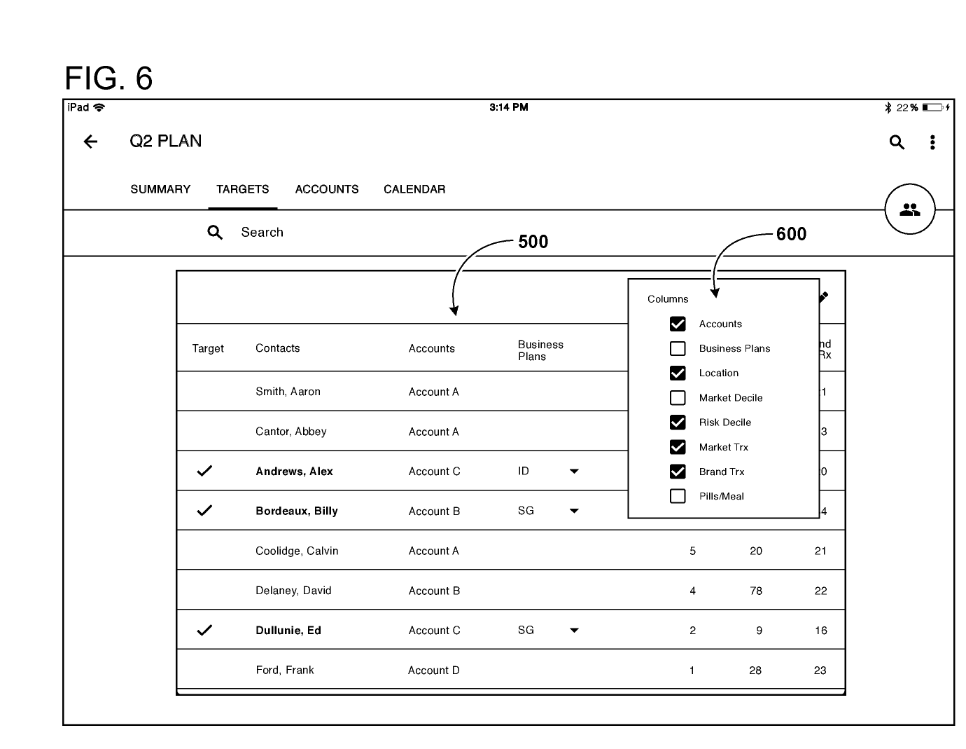

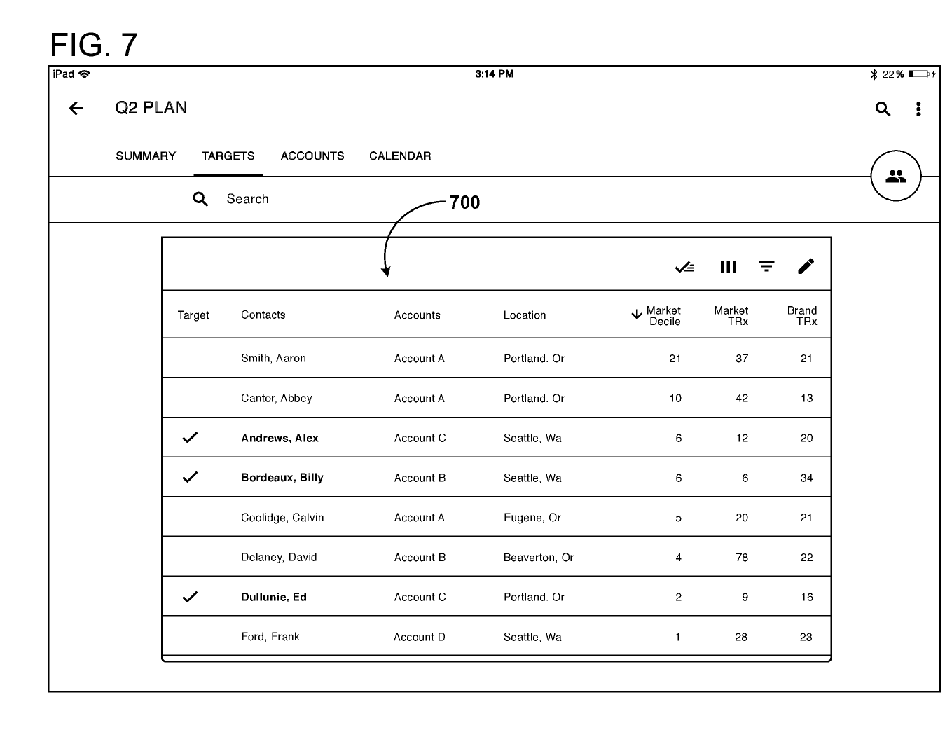

FIG. 6 illustrates an example interface 600 for filtering the list of providers of interface 500 according to targeting criteria, in accordance with various example embodiments. As shown by FIG. 6, the interface 600 may be superimposed or overlaid on top of the interface 500 of FIG. 5. The interface 600 may allow a user of representative device 150 to view the listed providers with associated account information (“accounts” in interface 600), business plans, location, market decile, risk decile, market TRx, Brand TRx, and Pills/Meals. The user of representative device 150 may select desired targeting criteria to display by clicking (for example, using a mouse-cursor interface) or tapping (e.g., using a touchscreen interface) a check box next to the desired targeting criteria. Once selected, the desired targeting criteria may be displayed in a revised list of providers of interface 700, as shown by FIG. 7. As shown by FIG. 7, the user of representative device 150 may have selected, for example using interface 600, to view providers or contacts associated with accounts A-D by location, market decile, market TRX, and brand TRx.

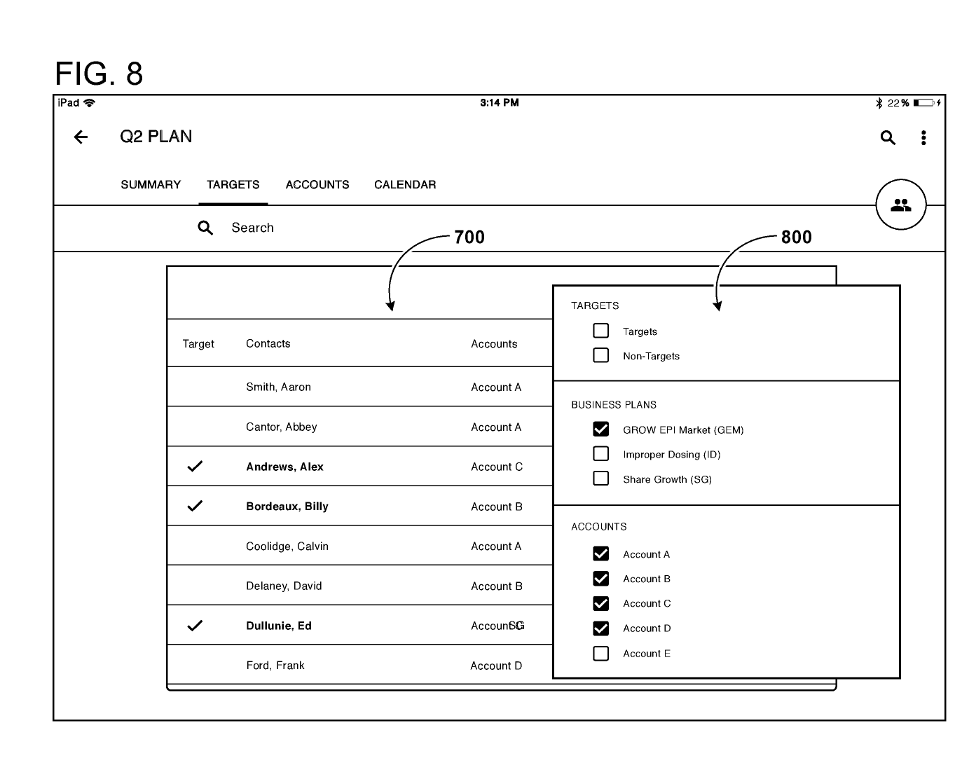

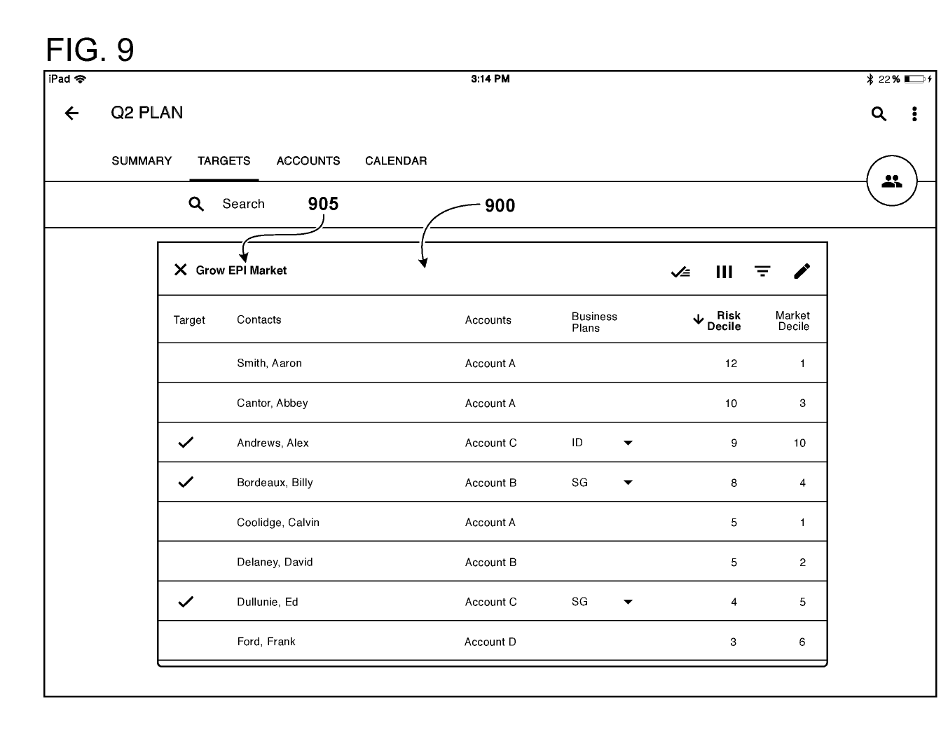

FIG. 8 illustrates an example interface 800 for filtering a list of providers according to various criteria, in accordance with various example embodiments. As shown by FIG. 8, the interface 800 may be superimposed or overlaid on top of the listing of providers of interface 700 of FIG. 7. The interface 800 may be used by the representative device 150 to filter the list of providers based on a selected business plan, such as Grow Epidemiology (EPI) Market business plan, an ID business plan, and/or an SG business plan. Additionally, interface 800 may be used by the representative device 150 to display the provider list according to desired accounts and/or targets or non-targets. The user of representative device 150 may select filtering criteria for filtering the provider listing by clicking or tapping a check box next to a desired filtering criterion. Once selected, a result of such filtering where only those providers that meet the criteria, is shown in interface 900 of FIG. 9. In FIG. 9, the filtering criteria 905 may be displayed above the list of providers in interface 900.

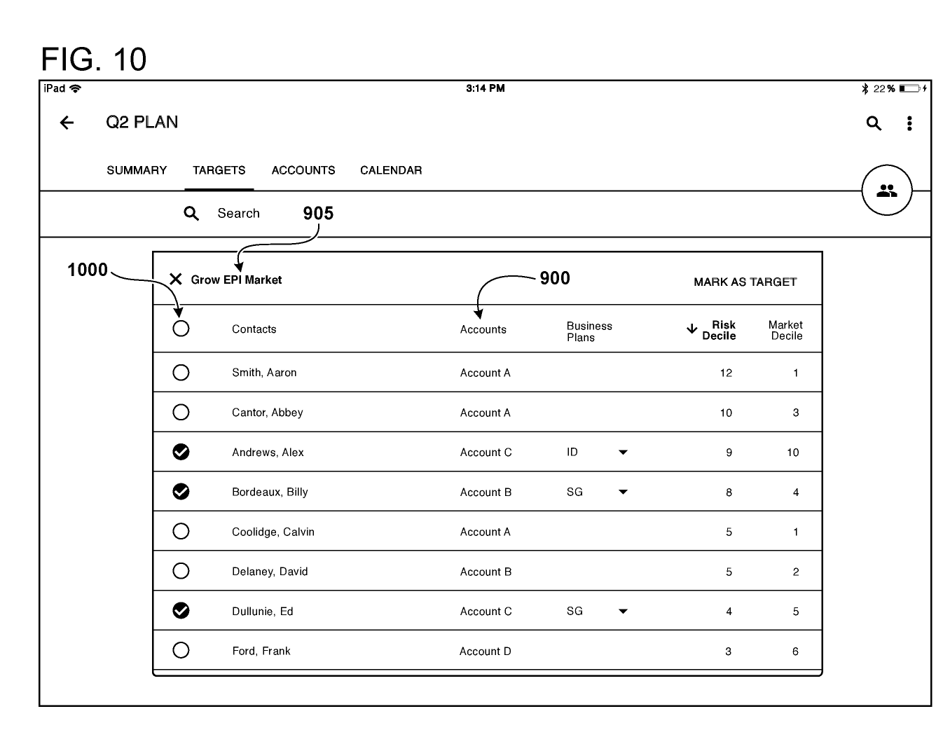

FIG. 10 illustrates an example interface 1000 for selecting provider targets, in accordance with various example embodiments. As shown by FIG. 10, the interface 1000 may be included in the interface 900. Using the interface 1000, the user of the representative device 150 may select desired providers to target by clicking or tapping a check circle next to each desired provider. Once selected, the representative device 150 may send an indication of the selected providers to the CPS 105 (see for example, operation 415 shown and described with regard to FIG. 4).

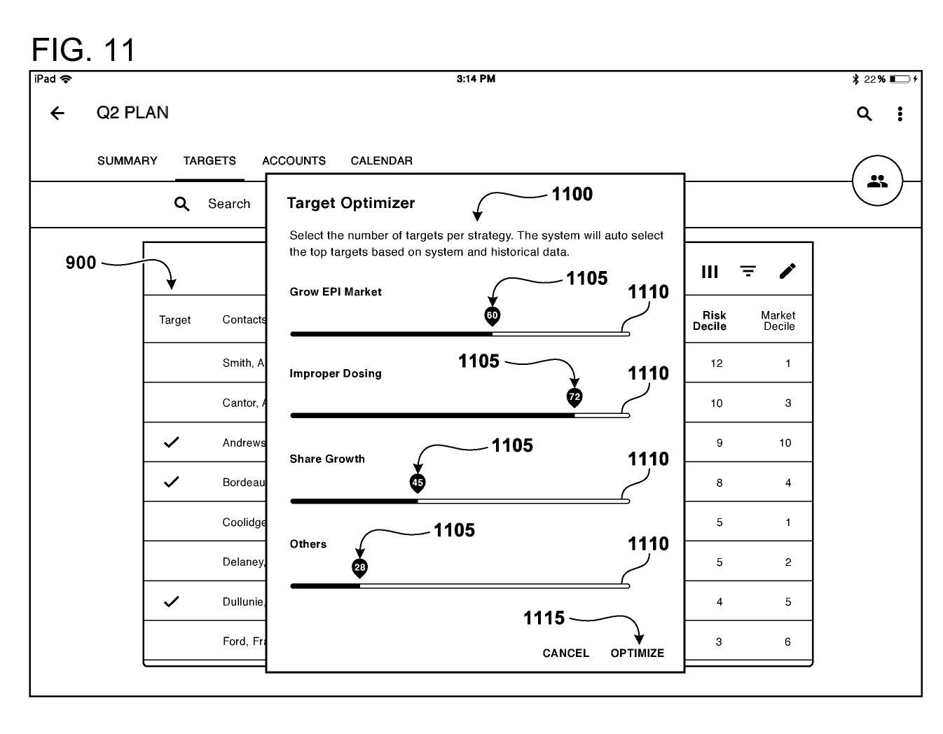

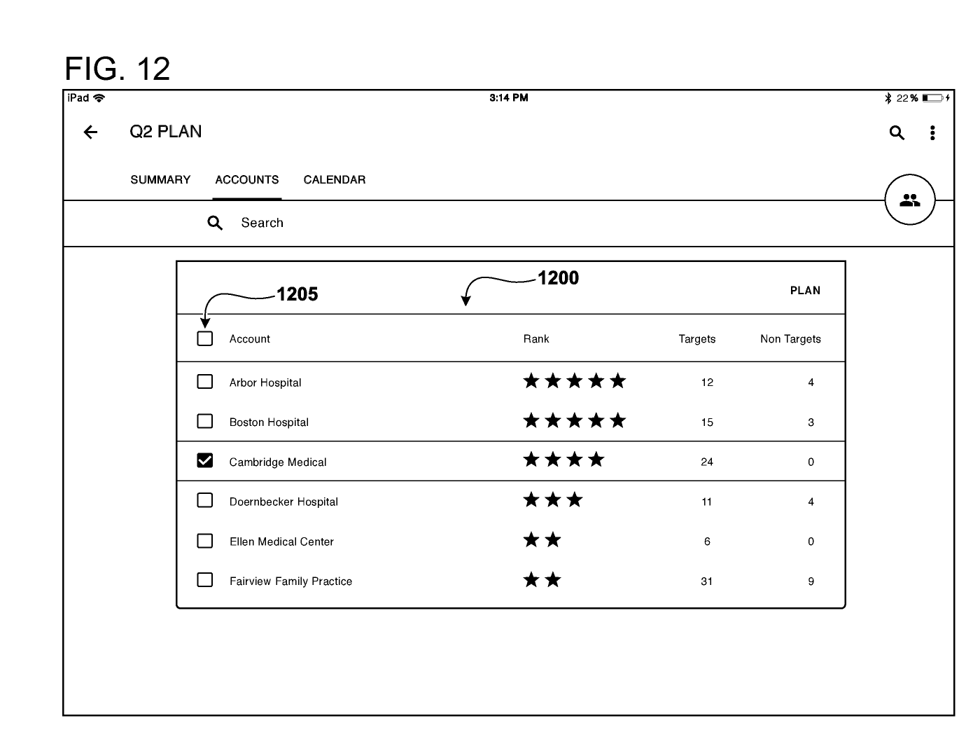

FIG. 11 illustrates an example interface 1100 for target optimization, in accordance with various example embodiments. The interface 1100 may be used by the representative device 150 to obtain providers based on desired targeting criteria. As shown by FIG. 11, the interface 1100 may be superimposed or overlaid on top of the interface 900. Additionally, the interface 1100 may include a slider 1105 for each targeting criterion. The user of representative device 150 may rank or prioritize each targeting criterion by moving a corresponding slider 1105 along its sliding scale 1110 to a desired value. As shown by FIG. 11, the selected value is shown within each slider 1105. In the example shown by FIG. 11, the selected values for each targeting criterion may indicate a desired number of providers to contact (also referred to as “targets”) per business plan or strategy. For example, as shown by FIG. 11, the improper dosing slider 1105 has been moved to a value of 72, which may indicate that the user of representative device 150 wishes to contact 72 providers regarding improper dosing issues. In other embodiments, the selected values for each business plan may indicate a weight to apply to each business plan. For example, the improper dosing slider 1105 being moved to a value of 72 may indicate that the user wishes to weight or emphasize contact with providers that would like to learn more about improper dosing issues by a factor of 72. Once selected, the user of the representative device 150 may then select the optimize button 1115, which may cause the representative device 150 to send an indication of the targeting criteria to the CPS 105 (see for example, operation 415 shown and described with regard to FIG. 4). The values that are selected using the sliders 1105 may be used by the CPS 105 to determine providers for the representative to contact, generate a plan for communicating with providers, and determine tactics for making contact with the selected providers. After the optimize button 1115 is selected, the CPS 105 may generate a plan and provide that plan to the representative device 150 using interface 1200 as shown by FIG. 12.

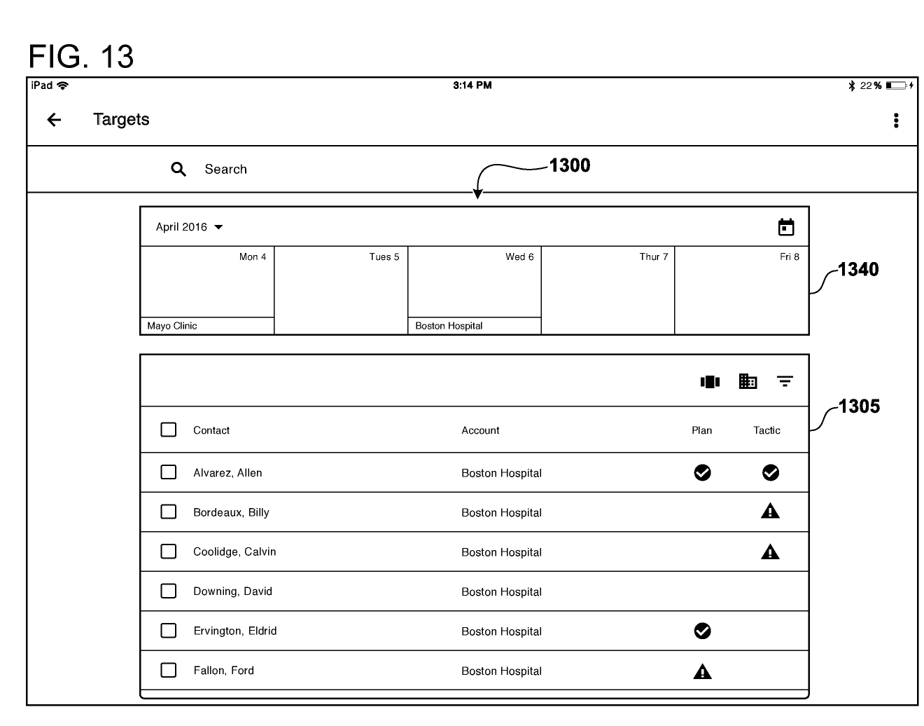

FIGS. 12-15 illustrate example interfaces to select providers to contact, in accordance with various embodiments. FIG. 12 shows a plan interface 1200 generated based on selected targeting criteria as discussed previously. The plan interface 1200 shows, for each account, a rank, a number of targets and a number of non-targets. The rank may be based on a probability of successful contact as calculated by the CPS 105, The number of targets may be a number of providers that are recommended for the user of representative device 150 to contact and the number of non-targets may be a number of providers that are not recommended for the user of representative device 150 to contact. The plan 1200 may also include an interface 1205, which may allow the user of representative device 150 to select one or more accounts to display the providers associated with the selected accounts by clicking or tapping a check box next to the desired account. For example, as shown by FIG. 12, the user has selected Cambridge Medical. Once selected, a list of providers, associated with the selected account may be displayed, such as a list of providers in interface 1300 shown by FIG. 13.

FIG. 13 shows an interface 1300 associated with a selected account from a plan 1200 of FIG. 12. The interface 1300 includes a calendar interface 1340 and a provider listing 1305. The calendar interface 1340 shows individual time periods including individual days (for example, Monday through Friday as shown by FIG. 13) of a week (for example, the week of April 4 as shown by FIG. 13) during a month (for example, April as shown by FIG. 13). The calendar interface 1340 also shows planned visits for certain accounts (for example, “Mayo Clinic” on Monday April 4 and “Boston Hospital” on Wednesday April 6 as shown by FIG. 13).

The provider listing 1305 shows, for each provider, an account, a plan status, and a tactic status. In this context, a plan may indicate a strategy for contacting a particular provider or target (for example, to discuss improper dosing issues as discussed previously), and a tactic may indicate how a planned contact is to occur (for example, during a lunch, a phone call, etc.). The plan status may indicate whether a plan for a particular provider is acceptable or has one or more conflicts. For example, as shown by FIG. 13, the plan status for provider Allen Alvarez is a check mark inside a circle, which may indicate that the plan for provider Allen Alvarez is acceptable and/or conflict free, while the plan status for provider Ford Fallon is an exclamation mark inside a triangle, which may indicate that there is a conflict or some other issues with the plan generated for Ford Fallon. Similarly, the tactic status may indicate whether a tactic for a particular provider is acceptable or has one or more issues. As shown by FIG. 13, the tactic status may include the same indicators as the plan status, for example, the check mark to indicate an acceptable tactic or an exclamation point to indicate one or more issues with a tactic. In addition, plan status and tactic status may be listed in the interface 1300 for a particular time period. For example, the plan statuses and tactic statuses shown by FIG. 13 may be for 4-8 Apr. 2016.

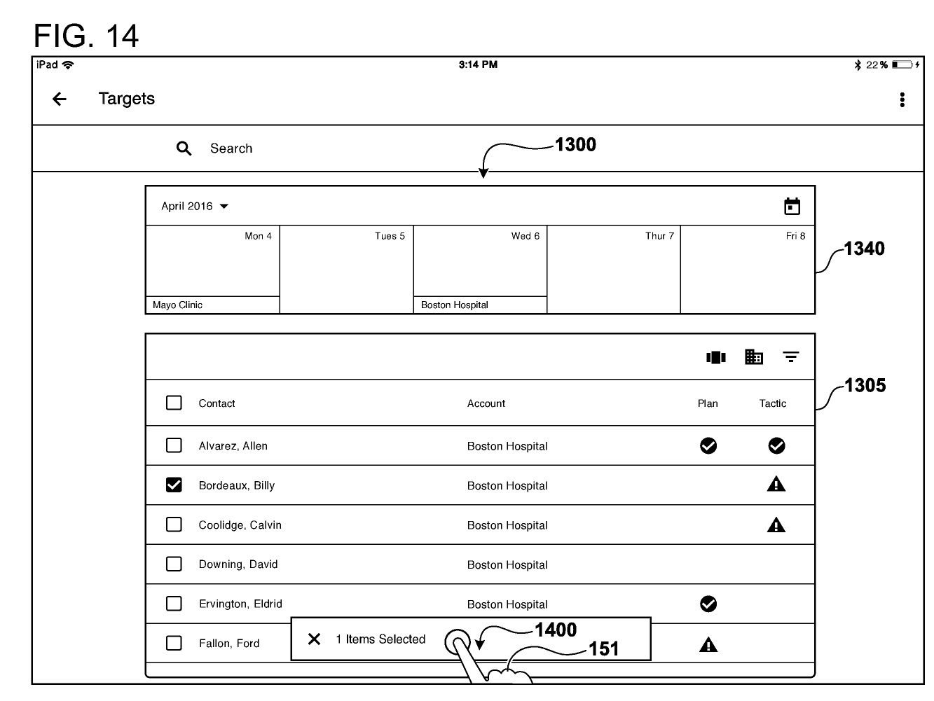

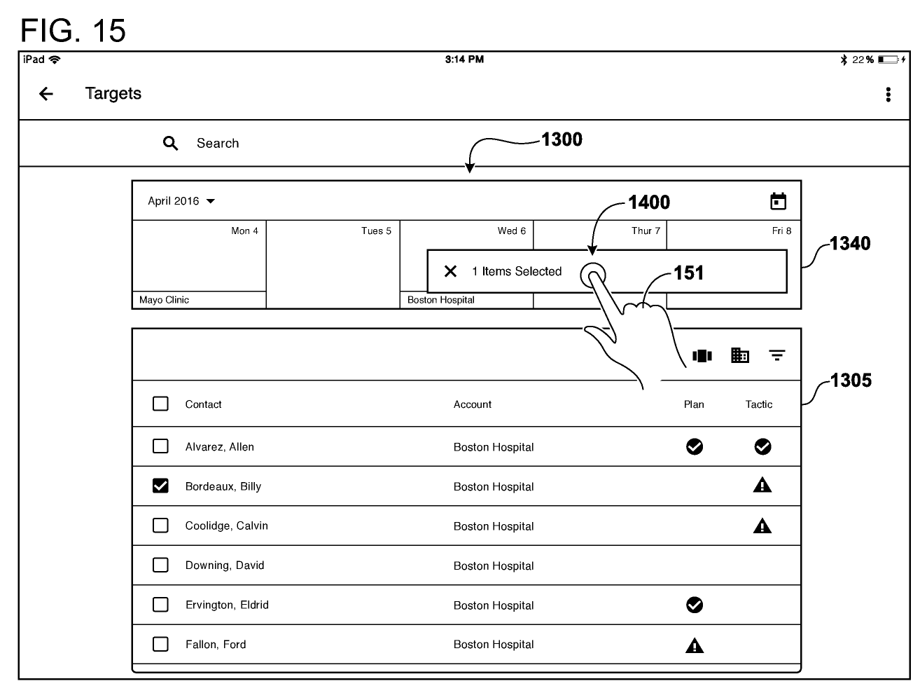

In order to view a plan status and/or a tactic status for a particular provider, a user of the representative device 150 may perform a drag and drop operation as shown by FIGS. 14-15. In FIG. 14, the user 151 (for example, the user of the representative device 150) may tap and hold a provider's entry to make a selection 1400. In FIG. 15, the user 151 may drag and drop the selection 1400 in a desired date listed by the calendar interface 1340. In embodiments, the user 151 may drop the selection 1400 in a listed date to view a plan status and/or tactic status of a particular provider for that particular day (for example, the selected item being dropped into Wednesday April 6 of the calendar interface 1340 as shown by FIG. 15).

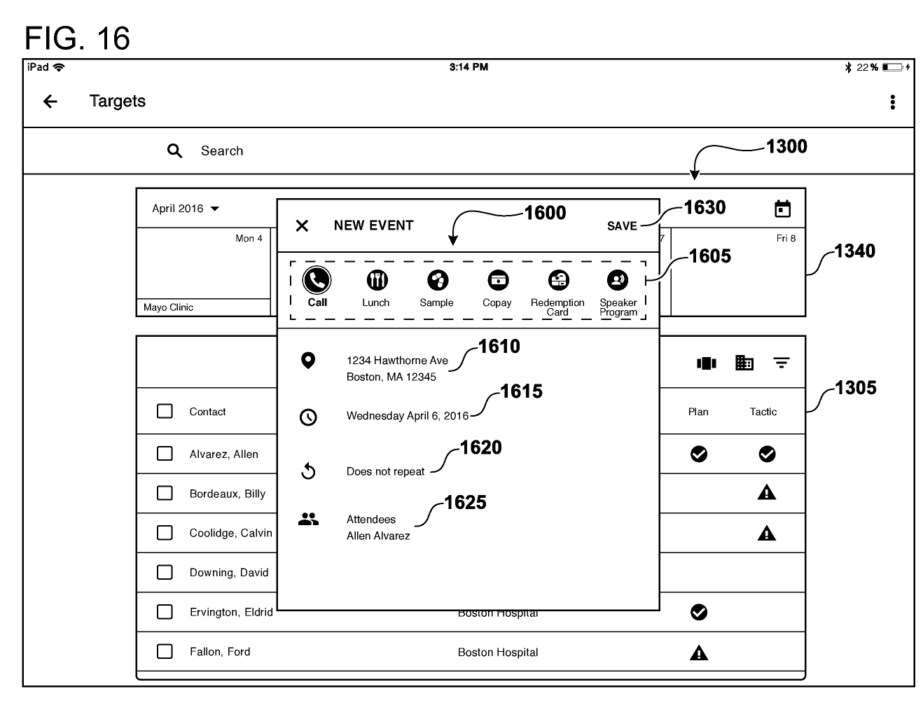

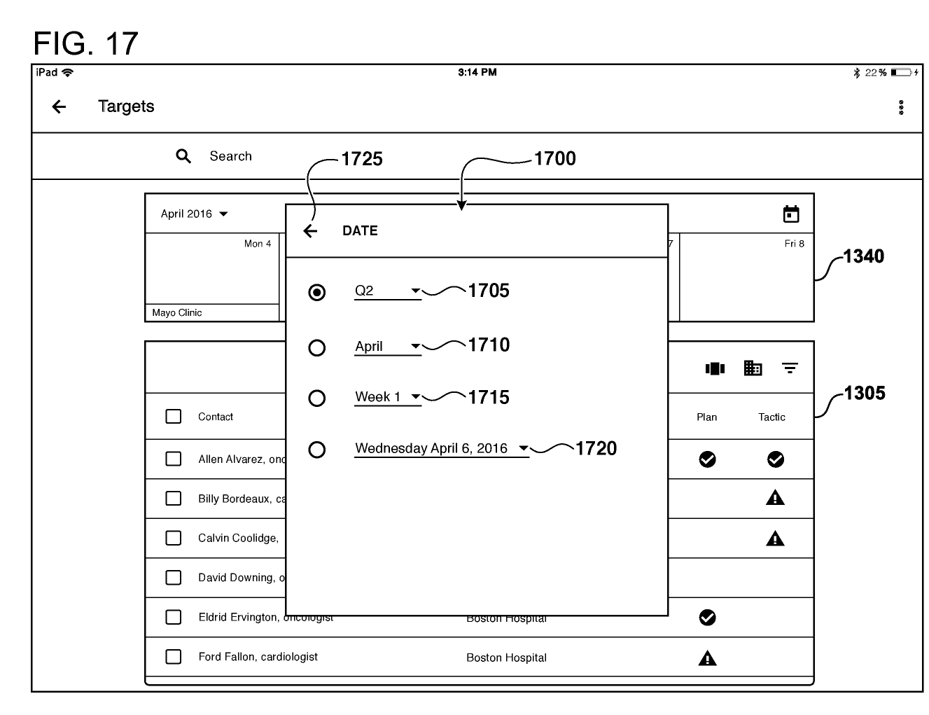

FIGS. 16-20 illustrate example interfaces for tactic selection, in accordance with various example embodiments. FIG. 16 shows an interface 1600 for editing or creating a tactic for contacting a provider/target, in accordance with various example embodiments. As shown by FIG. 16, interface 1600 may include tactics 1605 (inside the dashed rectangle), a provider address or location for the tactic 1610, a time of the tactic 1615, a periodicity 1620 of the tactic, and a target/provider 1625. As shown, the provider 1625 may be Allen Alvarez, the tactic 1605 may be a phone call (indicated by the highlighted “call” icon), the date/time 1610 for the contact may be Wednesday Apr. 6, 2016, and the periodicity 1620 may be “do not repeat” to indicate that this event is to take place one time. The user of the representative device 150 may alter any of the shown parameters by selecting a parameter. For example, user of the representative device 150 may adjust the time 1615 of the contact by tapping (or performing some other gesture) on the time 1615, which may present interface 1700 as shown by FIG. 17.

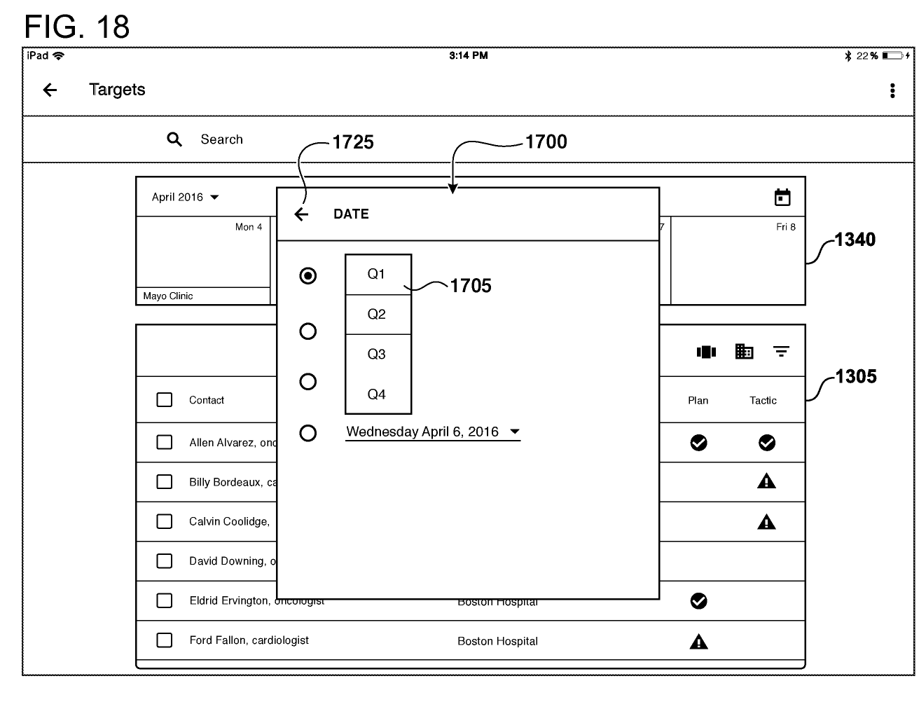

Referring to FIG. 17, the interface 1700 may be an interface for selecting a tactic time/date, in accordance with various example embodiments. As shown by FIG. 17, the user of the representative device 150 may select a drop down list 1705 to change the quarter for the tactic, select a drop down list 1710 to change the month of the tactic, select a drop down list 1715 to change the week for the tactic, and/or select a drop down list 1720 to change the day of the tactic. In some embodiments, altering one of the entries in one of the drop down lists may alter one or more other entries in the other drop down lists. For example, by changing the quarter from Q2 to Q1 in drop down list 1705 (as shown by FIG. 18) may cause the entries in the other drop down lists 1710, 1715, and 1720 to change to a month, week and/or day in Q3 (not shown).

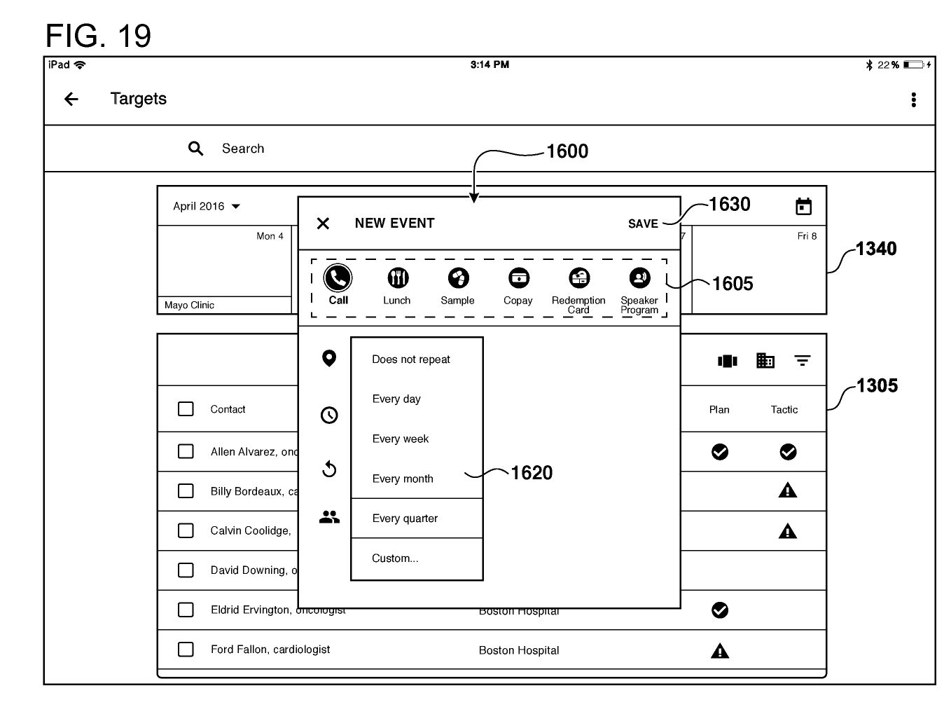

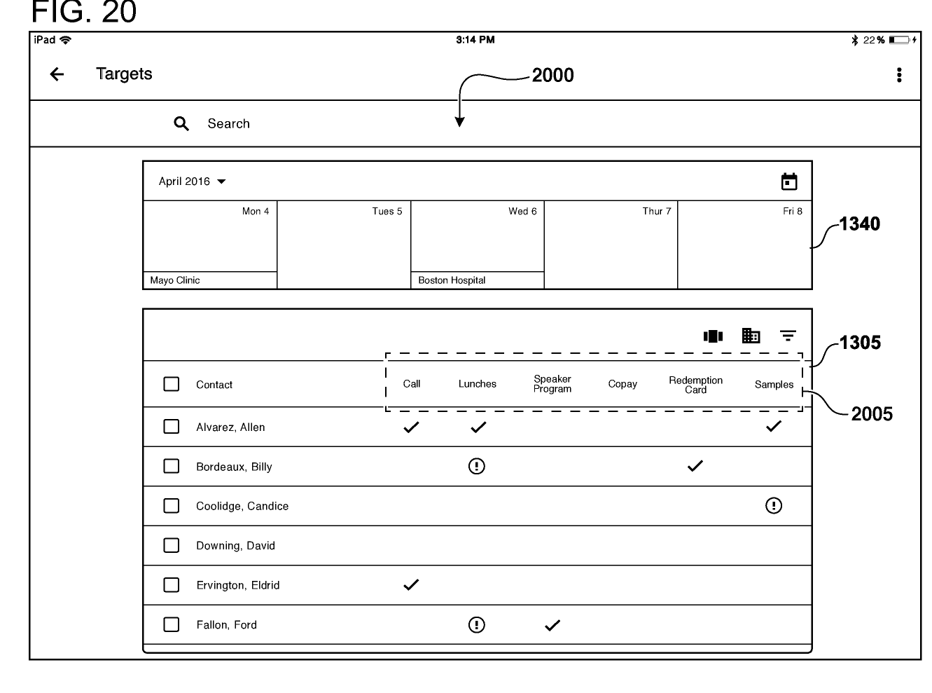

Once the user has selected the desired quarter, month, week, and day for the tactic, the user may select the back arrow 1725 to go back to the interface 1600 to change one or more other parameters of the tactic. For example, as shown by FIG. 19, the user of the representative device 150 may have selected the periodicity 1620, which has produced a drop down list overlaid on interface 1600. As shown by FIG. 19, the drop down list for the periodicity 1620 may allow the user to choose to repeat the tactic never (for example, by selecting “do not repeat” as shown), every day, every week, every month, every quarter, or a custom periodicity 1620. Referring to FIGS. 16 and 19, once the user has adjusted the desired tactic parameters, the user may select the save button 1630 to view an interface with a generated plan, such as the interface 2000 shown by FIG. 20.

FIG. 20 illustrates an example interface 2000 showing a generated plan including target statuses for listed providers, in accordance with various example embodiments. The interface 2000 may include the calendar interface 1340 and the provider listing 1305 as discussed previously. As shown by FIG. 20, a view of the provider listing 1305 may be changed from the view shown by FIGS. 13-15 to show a tactic status for each of the tactics 2005 (inside the dashed rectangle as shown by FIG. 20). The tactic statuses of FIG. 20 may be based on tactics, which were selected according to the embodiments discussed previously with regard to FIGS. 16-19. Similar to the tactic statuses of FIG. 13, the tactic statuses of FIG. 20 may indicate whether a tactic 2005 for a particular provider/target is acceptable (for example, indicated by check marks in FIG. 20) or whether a tactic 2005 has a conflict or some other issues (for example, indicated by exclamation points in FIG. 20). In embodiments, the user of the representative device 105 may tap on a tactic status to view information regarding the acceptance/conflict of the tactic.

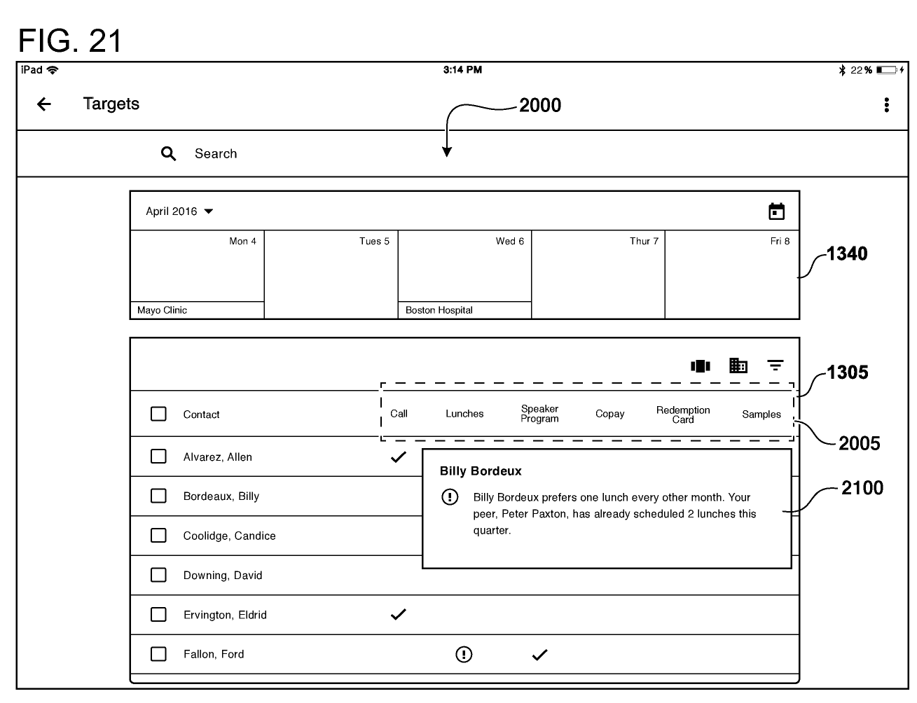

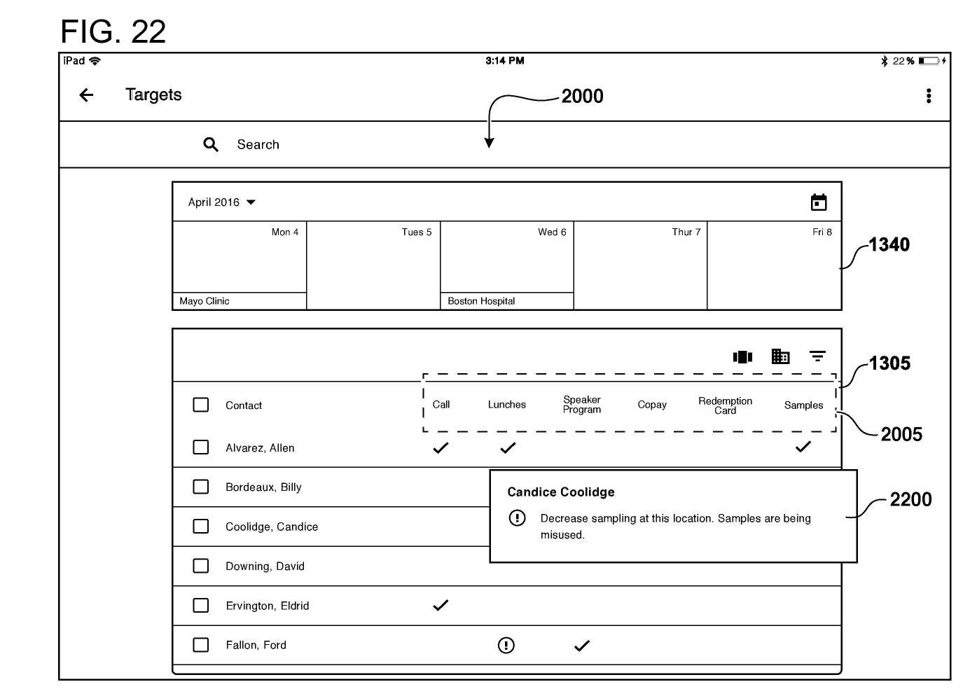

For example, FIG. 21 illustrates an interface 2100 showing tactic conflicts, in accordance with various example embodiments. The interface 2100 may be presented based on a selection of the tactic status associated with the provider Bill Bordeaux (for example, by tapping on the exclamation point in the Bill Bordeaux row under the “Lunches” column). The interface 2100 may be overlaid on the provider listing 1305 and may provide information regarding the tactic conflict. For example, in FIG. 21 the interface 2100 shows that the selected tactic 2005 (“Lunches” in FIG. 21) conflicts with another scheduled contact with the provider (by representative Peter Paxton in FIG. 21) and the provider's preferences (the provider's preference to schedule a lunch every other month in FIG. 21). In another example, FIG. 22 illustrates another interface 2200 showing tactic conflicts, in accordance with various example embodiments. The interface 2200 may be presented based on a selection of the tactic status associated with the provider Candice Coolidge (for example, by tapping on the exclamation point in the Candice Coolidge row under the “Samples” column). Similar to interface 2100, the interface 2200 may be overlaid on the provider listing 1305 and may provide information regarding the tactic conflict. For example, in FIG. 22 the interface 2200 shows that the selected tactic 2005 (“Samples” in FIG. 22) may result in regulatory issues (for example, misuse of samples as shown by interface 2200 of FIG. 22).

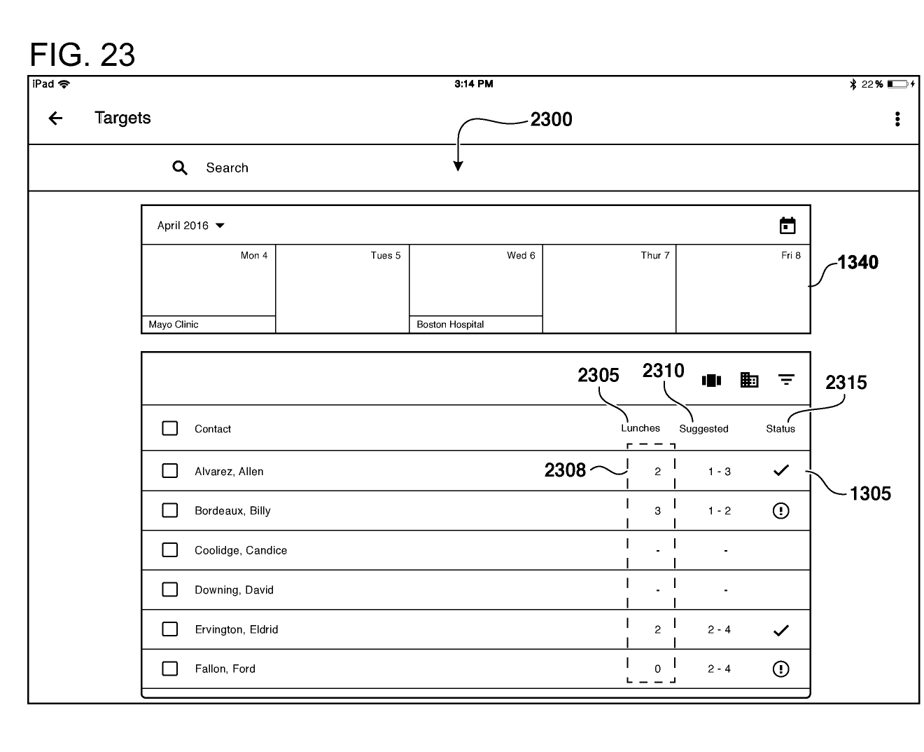

FIG. 23 illustrates an example interface 2300 showing a generated plan including tactic suggestions for listed providers, in accordance with various example embodiments. The interface 2300 may include the calendar interface 1340 and the provider listing 1305 as discussed previously. As shown by FIG. 23, a view of the provider listing 1305 may be changed from the view shown by FIGS. 13-15 and 20-22 to show, for a selected tactic 2305 of the tactics 2005, a number of planned meetings 2308 (inside the dashed rectangle in FIG. 23), suggestions 2310, and a tactic status 2315. For example, in FIG. 23, “Lunches” may be the selected tactic 2305, and the “Lunches” column may show a number of planned lunches 2308 for each provider. The suggestions 2310 may show a suggested amount of planned lunches for each provider, and the tactic status 2315 may indicate whether the number of scheduled/planned lunches conflicts with the suggested amount of lunches. For example, as shown by FIG. 23, the number of lunches scheduled with provider Allen Alvarez is within the suggested amount, and therefore, does not raise a conflict (indicated by the check mark in FIG. 23). By contrast, the number of lunches scheduled with provider Billy Bordeaux is not within the suggested amount, and therefore, does raise a conflict (indicated by the exclamation point in FIG. 23).

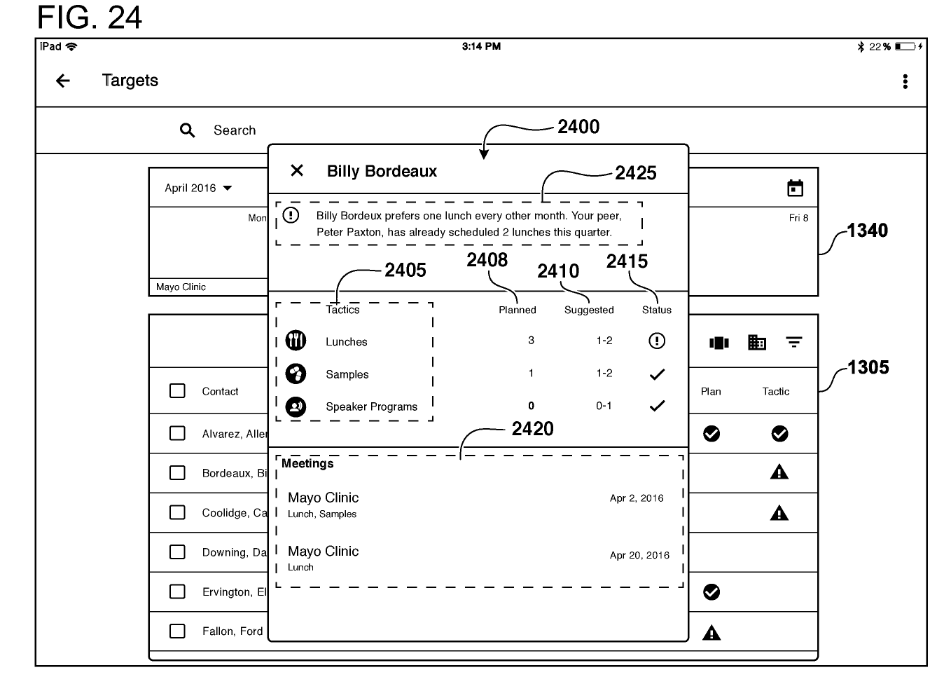

FIG. 24 illustrates an example interface 2400 listing of provider preferences of a selected provider, in accordance with various example embodiments. In FIG. 24, contacts for a particular provider (Billy Bordeaux) are shown. Here it can be seen which tactics 2405 the user of the representative device 150 is planning to contact the provider, and the number of planned meetings 2408 the user of the representative device 150 has planned with the provider. The interface 2400 may also include for each tactic 2405, suggestions 2410 and a tactic status 2415. The planned meetings 2408, suggestions 2410, and a tactic status 2415 may be the same or similar as the planned meetings 2308, the suggestions 2310, and the tactic status 2315, respectively. The interface 2400 also shows planned meetings 2420 for the selected provider and a tactic conflict notification 2425, which shows the same conflict as interface 2100 discussed previously. In embodiments, the tactic conflict notification 2425 may be displayed upon selection of the tactic status 2415 (for example, tapping on the exclamation point in FIG. 24).

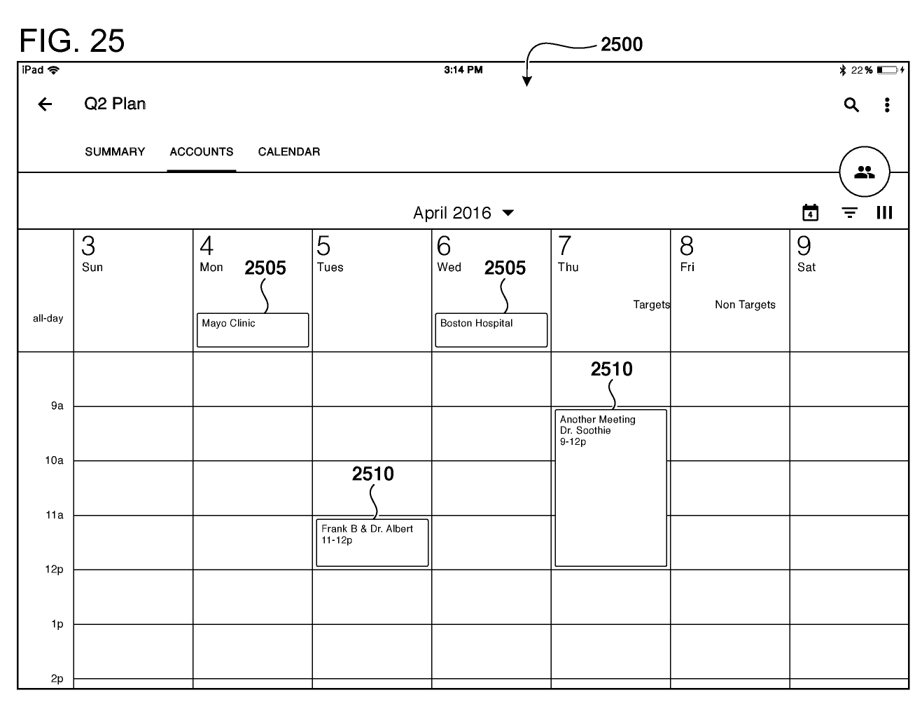

FIG. 25 illustrates an example calendar-based interface 2500, in accordance with various example embodiments. The calendar-based interface 2500 includes, for a particular week (Apr. 3-9, 2016 in FIG. 25), planned contacts 2505 for the user of the representative device 150 are shown with planned contacts 2510 for other representatives. This information may be used by the user of representative device 150 to determine how many additional contacts should be made with a particular provider and/or group of providers to avoid conflicts with other representatives.

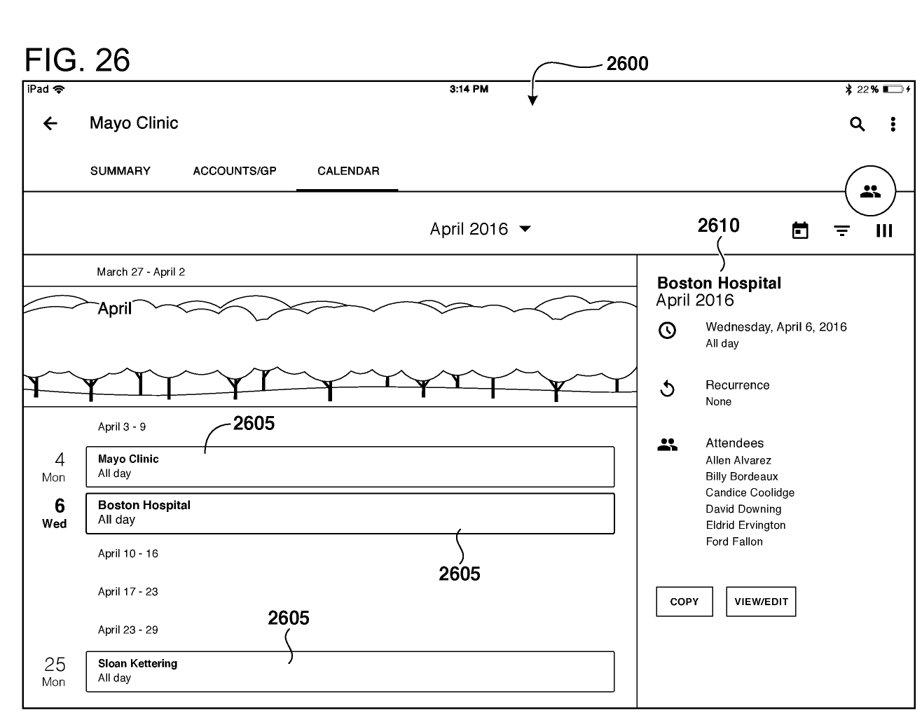

FIG. 26 illustrates another example calendar-based interface 2600, in accordance with various example embodiments. In contrast to the calendar-based interface 2500, the calendar-based interface 26500 includes, for a particular month (April 2016 in FIG. 26), planned contacts 2605 for the user of the representative device 150. The interface 2600 also includes interface 2610 showing contact details for a selected date (Wednesday April 6 as shown in FIG. 26) including the time planned for the contact (“All day” in FIG. 26), the periodicity or recurrence of the contact (“none” in FIG. 26), and the provider(s) to be contacted (listed under “Attendees” in FIG. 26). In other embodiments, other information may be shown by the interface 2610, such as the representative's number of contacts for various tiers (for example, as discussed with regard to FIG. 3), a contact goal for each listed provider. In some embodiments, interface 2600 may also provide a per-tier plan user interface elements. Activation of these interface elements may, in various embodiments, filter providers into providers that are in that tier, allowing a representative to plan with particularity for a given tier. In such embodiments, metrics for each tier may also be included, as well as more detailed metrics, such as, for example, average calls per day, provider type or specialty, for example cardiologists or primary care physicians, and other like information.

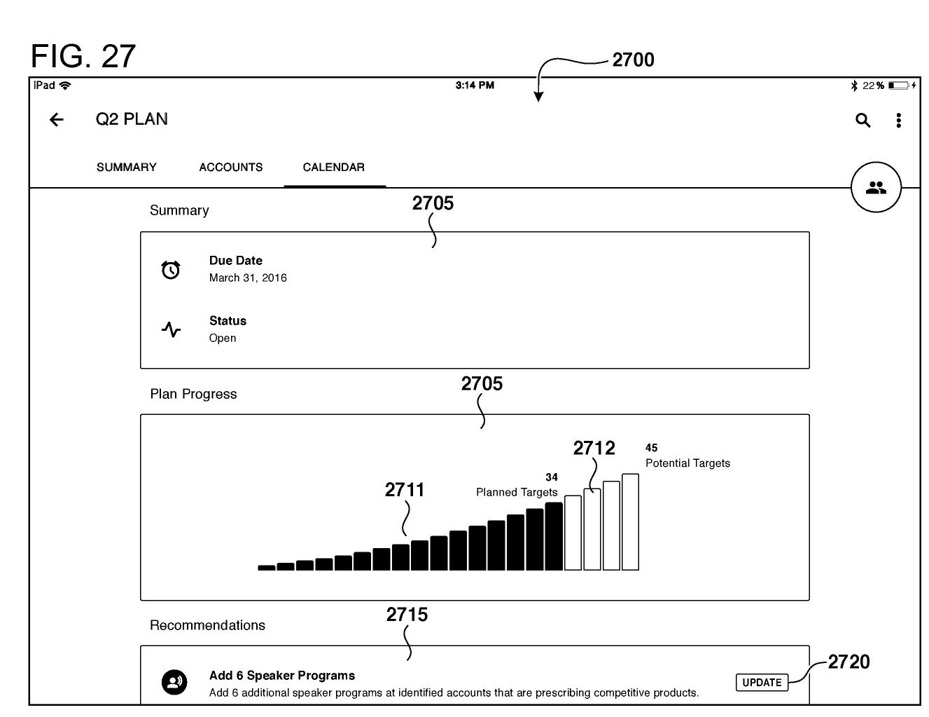

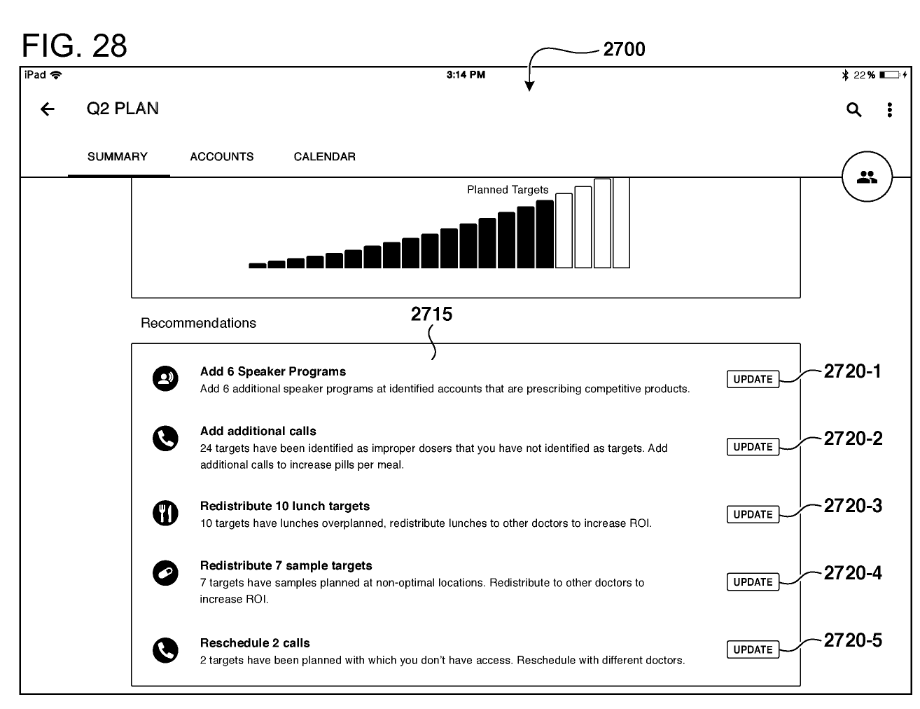

FIG. 27 illustrates an example progress indicator interface 2700, in accordance with various example embodiments. As shown by FIG. 27, the progress indicator interface 2700 may include a summary interface 2705, which may indicate a summary of metrics for the representative. The progress indicator interface 2700 may also include a planning progress indicator interface 2710, which may show a representative progress towards reaching a goal. For example, as shown by FIG. 27, the planning progress indicator interface 2710 shows that the user of representative device 150 has met 34 planned targets 2711 out of 45 potential targets 2712. In some embodiments, the interface 2700 may also include any of the metrics stored in the metrics storage 120 (not shown). In embodiments, the planning progress indicator interface 2710 may also be utilized by manager devices 155, 160 to determine how a particular representative is performing. In addition, interface 2700 also includes a recommendations interface 2715 that shows recommendations for reaching the goals indicated by the planning progress indicator interface 2710. The recommendations interface 2715 is shown in more detail by FIG. 28.

FIG. 28 illustrates another view of the progress indicator interface 2700, in accordance with various example embodiments. In particular, FIG. 28 shows a recommendations interface 2715, which includes various recommendations that may allow the user of representative device 150 to achieve the previously mentioned goals by adding providers to the contact plan; rescheduling planned contacts for other dates, times and/or places; altering a tactic for a particular provider; and/or the like. For example, the “Add additional calls” recommendation indicates that additional providers have been identified for the user of representative device 150 as potential targets. Based on this recommendation, the user of representative device 150 may select the update button 2720-2 to send a request to the CPS 105 for a listing of the potential targets, which may be displayed in a same or similar manner as discussed previously with regard to FIGS. 5-27. The user of representative device 150 may also select the update buttons 2720-1, 2720-3, 2720-4, 2720-5 to send a request to the CPS 105 for an interface to add additional speakers for a speaker program, adjust a tactic for various providers (“Redistribute 10 lunch targets” and “Redistribute 7 sample targets” in FIG. 28), and/or reschedule a planned contact (“Reschedule 2 calls” in FIG. 28). In other embodiments, other information may be shown by the progress indicator interface 2700 of FIGS. 27-28, such as goals, contact progress, and recommendations for particular groups of providers or accounts, and the like.

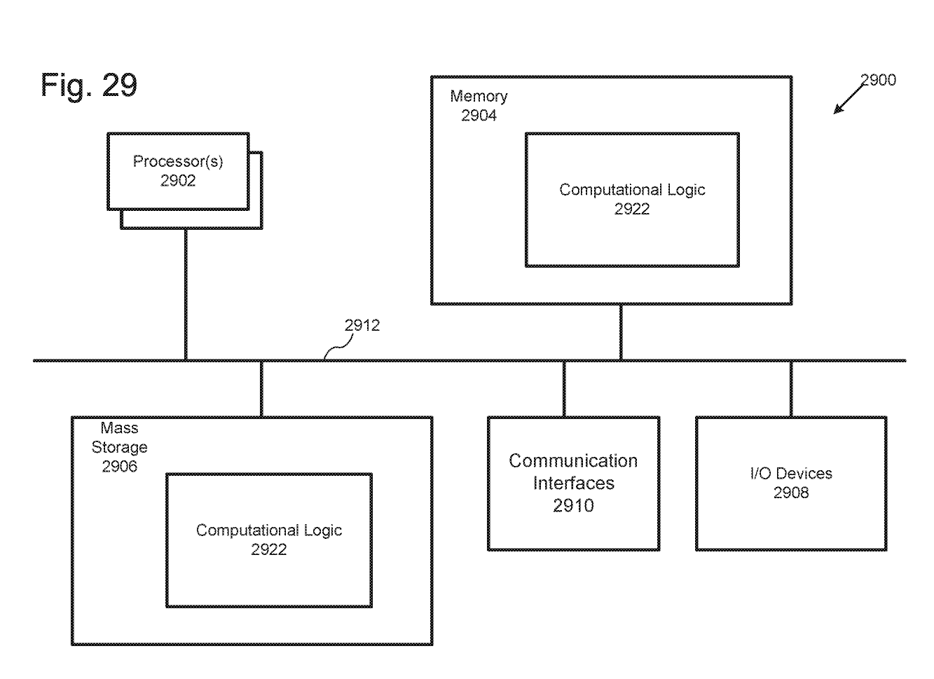

Referring now to FIG. 29, an example computer suitable for practicing various aspects of the present disclosure, including processes described herein, is illustrated in accordance with various embodiments. In various embodiments, the computer 2900 may correspond to CPS 105, representative device 150, and/or any other device shown and described with regard to FIG. 1. As shown by FIG. 29, computer 2900 may include one or more processors or processor cores 2902, and system memory 2904. For the purpose of this application, including the claims, the terms “processor” and “processor cores” may be considered synonymous, unless the context clearly requires otherwise. Additionally, computer 2900 may include mass storage devices 2906 (such as diskette, hard drive, flash drive, solid state drive, compact disc read only memory (CD-ROM) and so forth), input/output devices 2908 (such as display, keyboard, cursor control, remote control, gaming controller, image capture device, and so forth) and communication interfaces 2910 (such as network interface cards, modems, infrared receivers, radio receivers (e.g., cellular, WiFi, Bluetooth, etc.), and so forth). The elements may be coupled to each other via system bus 2912, which may represent one or more buses. In the case of multiple buses, they may be bridged by one or more bus bridges (not shown). Elements such as mass storage may be physically separate or remote.

Each of these elements may perform its conventional functions known in the art. In particular, system memory 2904 and mass storage devices 2906 may be employed to store a working copy and a permanent copy of the programming instructions implementing the operations associated with facilitation of communication with selected specialists as shown in processes described herein. The various elements may be implemented by assembler instructions supported by processor(s) 2902 or high-level languages, such as, for example, C, that can be compiled into such instructions.

The permanent copy of the programming instructions may be placed into permanent storage devices 2906 in the factory, or in the field, through, for example, a distribution medium (not shown), such as a compact disc (CD), or through communication interface 2910 (from a distribution server (not shown)). That is, one or more distribution media having an implementation of the processes described herein may be employed to distribute the programming instructions and program various computing devices.

The number, capability and/or capacity of these elements 2910-2912 may vary, depending on how computer 2900 is used. Their constitutions are otherwise known, and accordingly will not be further described.

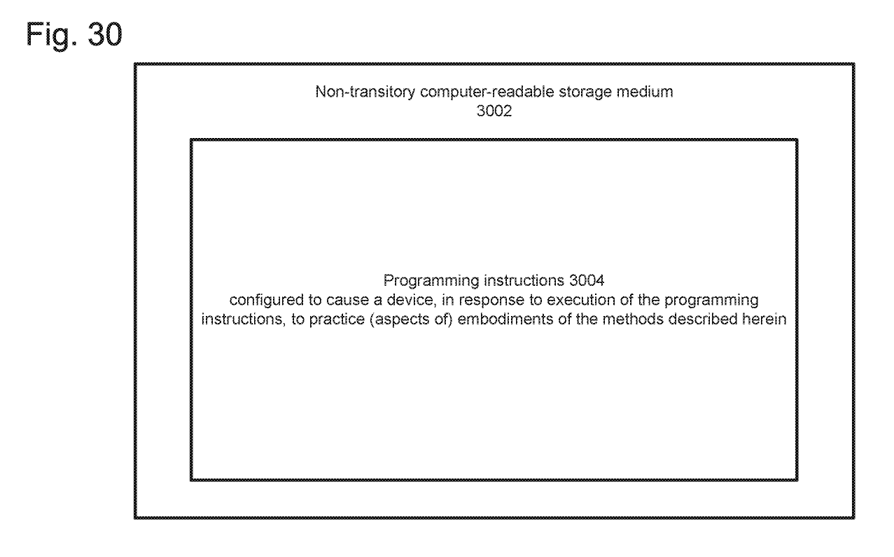

FIG. 30 illustrates an example least one computer-readable storage medium 3002 having instructions configured to practice all or selected ones of the operations associated with techniques described herein, such as the processes 300-400 shown and described with regard to FIGS. 3-4. As illustrated, at least one computer-readable storage medium 3002 may include a number of programming instructions 3004. Programming instructions 3004 may be configured to enable a device, e.g., computer 2900, CPS 105, representative device 150, etc., in response to execution of the programming instructions, to perform or implement (aspects of) various operations of processes described throughout this disclosure, but not limited to, to the various operations performed to modify and share content. In some embodiments, programming instructions 3004 may be disposed on multiple computer-readable storage media 2902 instead. In some embodiments, programming instructions 3004 may be disposed on computer-readable media 3002 that is transitory in nature, such as signals.

Any combination of one or more computer-usable or computer-readable media may be utilized. The computer-usable or computer-readable media may be, for example, but not limited to, an electronic, magnetic, optical, electromagnetic, infrared, or semiconductor system, apparatus, device, or propagation medium. More specific examples (a non-exhaustive list) of the computer-readable media would include the following: an electrical connection having one or more wires, a portable computer diskette, a hard disk, RAM, ROM, an erasable programmable read-only memory (for example, EPROM, EEPROM, or Flash memory), an optical fiber, a portable compact disc read-only memory (CD-ROM), an optical storage device, a transmission media such as those supporting the Internet or an intranet, or a magnetic storage device. Note that the computer-usable or computer-readable media could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable media may be any medium that can contain, store, communicate, propagate, or transport the program for use by or in connection with the instruction execution system, apparatus, or device. The computer-usable media may include a propagated data signal with the computer-usable program code embodied therewith, either in baseband or as part of a carrier wave. The computer-usable program code may be transmitted using any appropriate medium, including but not limited to wireless, wireline, optical fiber cable, radio frequency, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations or block diagrams of methods, apparatus (systems) and computer program products according to embodiments of the disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flowchart or block diagram block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart or block diagram block or blocks.

Referring back to FIG. 29, for one embodiment, at least one of processors 2902 may be packaged together with computational logic 2922 configured to practice aspects of processes described herein. For one embodiment, at least one of processors 2902 may be packaged together with computational logic 2922 configured to practice aspects of processes of described herein to form a System in Package (SiP). For one embodiment, at least one of processors 2902 may be integrated on the same die with computational logic 2922 configured to practice aspects of processes of described herein. For one embodiment, at least one of processors 2902 may be packaged together with computational logic 2922 configured to practice aspects of processes of described herein to form a System on Chip (SoC). For at least one embodiment, the SoC may be utilized in, e.g., but not limited to, a computing tablet.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

1. One or more non-transitory, computer-readable media including program code, which when executed by one or more processors, causes a computer device to:
generate a contact plan for a representative based on setup information, wherein the contact plan is to indicate individual providers of a plurality of providers for the representative to contact;
provide a first interface including the contact plan to a representative device used by the representative;
provide a second interface including one or more graphical control elements, wherein manipulation of the one or more graphical control elements are to indicate desired targeting criteria and indications of contacts between the representative and the individual providers indicated by the contact plan;
obtain the desired targeting criteria and the indications of the contacts between the representative and the individual providers indicated by the contact plan; and
update metrics based on the desired targeting criteria and the indications of the contacts.

2. The one or more non-transitory, computer-readable media of claim 1, wherein the computer device, in response to execution of the instructions, is to:
obtain the setup information, wherein the setup information comprises, for the individual providers, provider information, tier indicators, contact goals, contact history, availability information, and interaction history.

3. The one or more non-transitory, computer-readable media of claim 2, wherein to obtain the setup information, the computer device, in response to execution of the program code, is to:
query a provider storage to obtain the provider information;
query a metrics storage to obtain the tier indicators, the contact goals, and the interaction history; and
query a contacts storage to obtain the contact history and the availability information.

4. The one or more non-transitory, computer-readable media of claim 2, wherein the provider information comprises, for the individual providers, a geographical location; an association with one or more facilities; an association with one or more professional groups; one or more practice specialties; patient population information; a preferred language; or information regarding digital content objects obtained, requested, downloaded, and/or forwarded to other providers by the individual providers.

5. The one or more non-transitory, computer-readable media of claim 1, wherein the contact plan is to indicate targeting criteria for contacting the individual providers, wherein the targeting criteria is based at least in part on the desired targeting criteria or the updated metrics.

6. The one or more non-transitory, computer-readable media of claim 5, wherein to generate the contact plan, the computer device, in response to execution of the program code, is to:
obtain, from the representative device, a request for the contact plan and the desired targeting criteria;
identify, based on the desired targeting criteria, the individual providers and one or more tactics for contacting the individual providers; and
modify the contact plan to include the individual providers and the one or more tactics.

7. The one or more non-transitory, computer-readable media of claim 6, wherein the targeting criteria comprises a desired periodicity, one or more desired topics, and/or one or more desired tactics for contacting the individual providers.

8. The one or more non-transitory, computer-readable media of claim 7, wherein to generate the contact plan, the computer device, in response to execution of the program code, is to:
modify the contact plan based on the tier indicators, the contact goals, and the interaction history obtained from the metrics storage.

9. The one or more non-transitory, computer-readable media of claim 1, wherein the indications of the contacts comprise information indicative of contact success with the individual providers, information indicative of whether future contacts with the individual providers are warranted, and information indicative of whether a follow-up contact is desirable.

10. The one or more non-transitory, computer-readable media of claim 9, wherein to update the metrics, the computer device, in response to execution of the program code, is to:
store, in the metrics storage, the indications of the contacts in association with the targeting criteria.

11. One or more non-transitory, computer-readable media including program code, which when executed by one or more processors, causes a computer device to:
obtain, from a contact planning system, a first interface including a contact plan, wherein the contact plan is to indicate individual providers of a plurality of providers for a representative to contact, wherein the contact plan is based on setup information;
provide, to the contact planning system using one or more graphical control elements of a second interface, desired targeting criteria and indications of contacts between the representative and the individual providers indicated by the contact plan, wherein the desired targeting criteria comprises a desired periodicity, one or more desired topics, or one or more desired tactics for contacting the individual providers; and
obtain, from a contact planning system via the first interface, a modified contact plan that indicates other individual providers for the representative to contact, wherein the modified contact plan is based on the desired targeting criteria and the indications of the contacts.

12. The one or more non-transitory, computer-readable media of claim 1, wherein the setup information comprises, for the individual providers, provider information, tier indicators, contact goals, contact history, availability information, and interaction history.

13. The one or more non-transitory, computer-readable media of claim 12, wherein the provider information comprises, for the individual providers, a geographical location; an association with one or more facilities; an association with one or more professional groups; one or more practice specialties; patient population information; a preferred language; or information regarding digital content objects obtained, requested, downloaded, and/or forwarded to other providers by the individual providers.

14. The one or more non-transitory, computer-readable media of claim 11, wherein to obtain the contact plan, the computer device, in response to execution of the program code, is to:
render, in a dedicated application implemented by the computer device, the first interface including the contact plan and the second interface including the one or more graphical control elements, wherein the contact plan indicates targeting criteria for contacting the individual providers based at least in part on the desired targeting criteria and metrics associated with the individual providers.

15. The one or more non-transitory, computer-readable media of claim 14, wherein the computer device, in response to execution of the program code, is to:
render, in the dedicated application in response to selection of a graphical control element in the first interface, the second interface including overlaid on the first interface.

16. The one or more non-transitory, computer-readable media of claim 15, wherein the modified contact plan indicates a tactic for contacting the individual providers based on the one or more desired tactics and a tactic status for each indicated tactic, wherein the tactic status is to indicate whether the indicated tactic is acceptable or has one or more conflicts.

17. The one or more non-transitory, computer-readable media of claim 1, wherein the indications of the contacts comprises information indicative of contact success with the individual providers, information indicative of whether future contacts with the individual providers are warranted, and information indicative of whether a follow-up contact is desirable.

18. The one or more non-transitory, computer-readable media of claim 17, wherein the modified contact plan indicates one or more recommendations based on the indications of the contacts and progress toward a goal set by a user of the computer device.

19. An apparatus to implement a contact planning system, the apparatus comprising:
means for obtaining setup information;
means for generating a contact plan for a representative based on the setup information, wherein the contact plan indicates individual providers of a plurality of providers for the representative to contact and tactics for contacting the individual providers;
means for providing the contact plan via a first interface to a representative device used by the representative;
means for obtaining, via a second interface, indications of contacts between the representative and the individual providers indicated by the contact plan;
means for updating metrics based on the indications of the contacts; and
means for modifying the contact plan based on the updated metrics.

20. The apparatus of claim 19, wherein the setup information comprises, for the individual providers, provider information, tier indicators, contact goals, contact history, availability information, and interaction history.

21. The apparatus of claim 20, wherein the means for obtaining the setup information comprises:
means for querying a provider storage to obtain the provider information;
means for querying a metrics storage to obtain the tier indicators, the contact goals, and the interaction history; and
means for querying a contacts storage to obtain the contact history and the availability information.

22. The apparatus of claim 21, wherein the provider information comprises, for the individual providers, a geographical location; an association with one or more facilities; an association with one or more professional groups; one or more practice specialties; patient population information; or a preferred language.

23. The apparatus of claim 22, wherein the means for modifying the contact plan comprises:
means for modifying the contact plan based on the provider information obtained from the provider storage and based on the tier indicators, the contact goals, and the interaction history obtained from the metrics storage.

24. The apparatus of claim 22, further comprising:
means for obtaining, via the first interface, a request for the contact plan and a selection of the individual providers;
means for obtaining, via the second interface, filter criteria; and
means for filtering, based on the filter criteria, a listing of the individual providers, and wherein the means for modifying the contact plan comprises means for modifying the contact plan to include the filtered listing.

25. The apparatus of claim 24, further comprising:
means for obtaining, via the first interface, an indication of a date or time when the representative wishes to contact the selected individual providers, and
wherein the means for modifying the contact plan comprises means for modifying the contact plan based on the indication of the time or date and the availability information obtained from the contacts storage.
